(19) United States
(12) Patent Application Publication
(10) Pub. No.: US 2026/0014700 A1
(43) Pub. Date: Jan. 15, 2026

(54) CONNECTION JIG AND CONNECTION METHOD

(71) Applicant: I-PEX Inc., Kyoto-shi (JP)

(72) Inventor: Hajime TAGOMORI, Fukuoka (JP)

(73) Assignee: I-PEX Inc., Kyoto-shi (JP)

(21) Appl. No.: 19/337,089

(22) Filed: Sep. 23, 2025

Related U.S. Application Data
(63) Continuation of application No. PCT/JP2024/010979, filed on Mar. 21, 2024.

(30) Foreign Application Priority Data
Mar. 31, 2023 (JP) 2023-058441

(51) Int. Cl. B25J 9/16; B25J 9/10; B25J 11/00; B25J 13/08

(52) U.S. Cl. CPC B25J 9/1633; B25J 9/108; B25J 9/163; B25J 9/1679; B25J 11/005; B25J 13/085

(57) ABSTRACT

A connection jig includes a sensor provided with a passive part and a fixation part that are respectively arranged at one end and another end in a direction of a rotation axis thereof and detecting a force around the rotation axis with respect to the passive part, a first joining part joining the passive part and a holding part, a second joining part joining the fixation part and a automated transportation part, a third joining part joined to the first joining part and supported by the second joining part to be rotatable around the rotation axis, and a bearing part provided between and attached to the first joining part and the third joining part and arranged at a position where a rotation axis thereof is coaxial with the rotation axis of the sensor.

### CROSS-REFERENCE TO RELATED APPLICATION

This application is a continuation of International Application No. PCT/JP2024/010979, filed on Mar. 21, 2024, the entire contents of which are herein incorporated by reference, and which is based upon and claims the benefit of priority to Japanese Patent Application No. 2023-058441, filed on Mar. 31, 2023, the entire contents of which are herein incorporated by reference.

### BACKGROUND OF THE INVENTION

### 1. Field of the Invention

A disclosed embodiment relates to a connection jig and a connection method.

### 2. Description of the Related Art

A manufacturing step for electrical equipment, etc., may include a step that connects a connection target such as a connector or a wiring member with a plate shape to a target to be connected such as another connector, and automation of such a step is advanced by automatic transportation with a utilized robot, etc., in recent years.

For example, Japanese Patent Application Publication No. 2021-119024 discloses a robot system where a force that acts on an end effector at a time of connection work is detected by a hexaxial force sensor, so that it is possible to execute connection of a wiring member with a plate shape to a connector accurately.

However, in a technique as described in Japanese Patent Application Publication No. 2021-119024 as described above, in a case where a force is applied to an end effector that is connected to a hexaxial force sensor from a direction that is different from a connection direction thereof, force detection accuracy of such a hexaxial force sensor may be degraded by an influence of such a force. Hence, in a robot system as described in Japanese Patent Application Publication No. 2021-119024, it may be impossible to execute connection between a connection target and a target to be connected accurately.

### SUMMARY OF THE INVENTION

A connection jig according to an aspect of an embodiment includes a sensor that is provided with a passive part and a fixation part that are respectively arranged at one end and another end in a direction of a rotation axis thereof, and detects a force around the rotation axis with respect to the passive part, a first joining part that is arranged between the passive part of the sensor and a holding part that holds a connection target that is connected to a target to be connected, and joins the passive part of the sensor and the holding part, a second joining part that is arranged between the fixation part of the sensor and an automated transportation part that automatically transports a connection target that is held by the holding part to a predetermined position, and joins the fixation part of the sensor and the automated transportation part, a third joining part that is joined to the first joining part and is supported by the second joining part to be rotatable around the rotation axis, and a bearing part that is provided between and attached to the first joining part and the third joining part, and is arranged at a position where a rotation axis thereof is coaxial with the rotation axis of the sensor.

### BRIEF DESCRIPTION OF THE DRAWING(S)

FIG. 1 is a diagram that illustrates an example of a configuration of an assembly system according to an embodiment.

FIG. 2 is a perspective view that illustrates an example of a connection jig and a holding part according to an embodiment.

FIG. 3 is a perspective view that illustrates an example of a position correction part according to an embodiment.

FIG. 4 is a perspective view that illustrates another example of a position correction part according to an embodiment.

FIG. 5 is a perspective view that illustrates an example of a joining part according to an embodiment.

FIG. 6 is an exploded perspective view (part 1) that illustrates an example of a joining part according to an embodiment.

FIG. 7 is an exploded perspective view (part 2) that illustrates an example of a joining part according to an embodiment.

FIG. 8 is a perspective view (part 1) that illustrates an example of a sensor according to an embodiment.

FIG. 9 is a perspective view (part 2) that illustrates an example of a sensor according to an embodiment.

FIG. 10 is a perspective view (part 1) that illustrates an example of a configuration of a first joining part according to an embodiment.

FIG. 11 is a perspective view (part 2) that illustrates an example of a configuration of a first joining part according to an embodiment.

FIG. 12 is a perspective view (part 3) that illustrates an example of a configuration of a first joining part according to an embodiment.

FIG. 13 is a diagram that illustrates an example of a gap between a first joining part and a sensor according to an embodiment.

FIG. 14 is a perspective view (part 1) that illustrates an example of a configuration of a second joining part according to an embodiment.

FIG. 15 is a perspective view (part 2) that illustrates an example of a configuration of a second joining part according to an embodiment.

FIG. 16 is a diagram that illustrates an example of a gap between a second joining part and a sensor according to an embodiment.

FIG. 17 is a perspective view (part 1) that illustrates an example of a configuration of a third joining part according to an embodiment.

FIG. 18 is a perspective view (part 2) that illustrates an example of a configuration of a third joining part according to an embodiment.

FIG. 19 is a perspective view that illustrates an example of a configuration of a bearing part according to an embodiment.

FIG. 20 is a diagram that illustrates an example of an insertion method for a bearing part to a shaft part of a third joining part according to an embodiment.

FIG. 21 is a diagram that illustrates an example of an insertion method for a bearing part to each of an attachment surface of a second joining part and a shaft part of a third joining part according to an embodiment.

FIG. 22 is a cross-sectional view of a part of a joining part according to an embodiment where the cross-sectional view is along an XZ-axis-plane that includes a rotation axis.

FIG. 23 is a side view for explaining a force that is applied to a sensor in a case where a load is applied to a holding part according to an embodiment.

FIG. 24A is a cross-sectional view for explaining a force that is applied to a sensor in a case where a load is applied to a holding part according to an embodiment. FIG. 24B is a cross-sectional view for explaining a force that is applied to a sensor in a case where a load is applied to a holding part according to an embodiment.

FIG. 25 is a perspective view that illustrates an example of a configuration of a fourth joining part according to an embodiment.

FIG. 26 is a plane that illustrates an example of a configuration of a fourth joining part according to an embodiment.

FIG. 27 is a perspective view that illustrates an example of each of a connection target and a target to be connected that are connected by an assembly system according to an embodiment.

FIG. 28 is a side view that illustrates an example of each of a connection target and a target to be connected that are connected by an assembly system according to an embodiment.

FIG. 29 is a diagram for explaining a connection method for a connection target to a target to be connected by an assembly system according to an embodiment.

FIG. 30 is a diagram that illustrates a relationship between a connection target and a target to be connected for explaining a connection method for a connection target to a target to be connected by an assembly system according to an embodiment.

FIG. 31 is a diagram that illustrates an example of a change of an insertion force at a connection step for a connection target to a target to be connected by an assembly system according to an embodiment.

FIG. 32 is a perspective view that illustrates an example of a changing method for an attachment angle of each of a first joining part and a third joining part according to an embodiment.

FIG. 33 is a cross-sectional view (part 1) that illustrates another configuration example of a joining part according to an embodiment.

FIG. 34 is a cross-sectional view (part 2) that illustrates another configuration example of a joining part according to an embodiment.

FIG. 35 is a cross-sectional view (part 3) that illustrates another configuration example of a joining part according to an embodiment.

FIG. 36 is a cross-sectional view (part 4) that illustrates another configuration example of a joining part according to an embodiment.

FIG. 37 is a cross-sectional view (part 5) that illustrates another configuration example of a joining part according to an embodiment.

FIG. 38 is a diagram (part 1) that illustrates another example of a connection target that is connected to a target to be connected by a connection jig according to an embodiment.

FIG. 39 is a diagram where a part that is surrounded by a frame W as described in FIG. 38 is enlarged where the diagram is to illustrate an example of a flow of an unlock step that moves a lock state of a lock member of a target to be connected, from a lock position where a connection target is heled with respect to a target to be connected to an unlock position that is different from such a lock position, by a connection jig according to an embodiment.

FIG. 40 is a diagram that illustrates an example of a change of a load that is applied to a connection jig at an unlock step that moves a lock state of a lock member of a target to be connected, from a lock position where a connection target is held with respect to a target to be connected to an unlock position that is different from such a lock position, by a connection jig according to an embodiment.

FIG. 41 is a diagram (part 2) that illustrates another example of a connection target that is connected to a target to be connected by a connection jig according to an embodiment.

FIG. 42 is a diagram where a part that is surrounded by a frame W as described in FIG. 41 is enlarged where the diagram is to illustrate an example of a flow of a lock step that moves a lock member of a target to be connected to a lock position where a connection target is held with respect to the target to be connected, by a connection jig according to an embodiment.

FIG. 43 is a diagram that illustrates an example of a change of a load that is applied to a connection jig at a lock step that moves a lock member of a target to be connected, to a lock position where a connection target is held with respect to the target to be connected, by a connection jig according to an embodiment.

FIG. 44 is a perspective view that illustrates yet another example of a connection target that is connected to a target to be connected by a connection jig according to an embodiment.

### DETAILED DESCRIPTION OF THE PREFERRED EMBODIMENT(S)

Hereinafter, an embodiment(s) of a connection jig and a connection method that uses it as disclosed in the present application will be explained in detail, with reference to the drawing(s). Additionally, this invention is not limited by an embodiment(s) as illustrated below.

### 1. Configuration of Assembly System

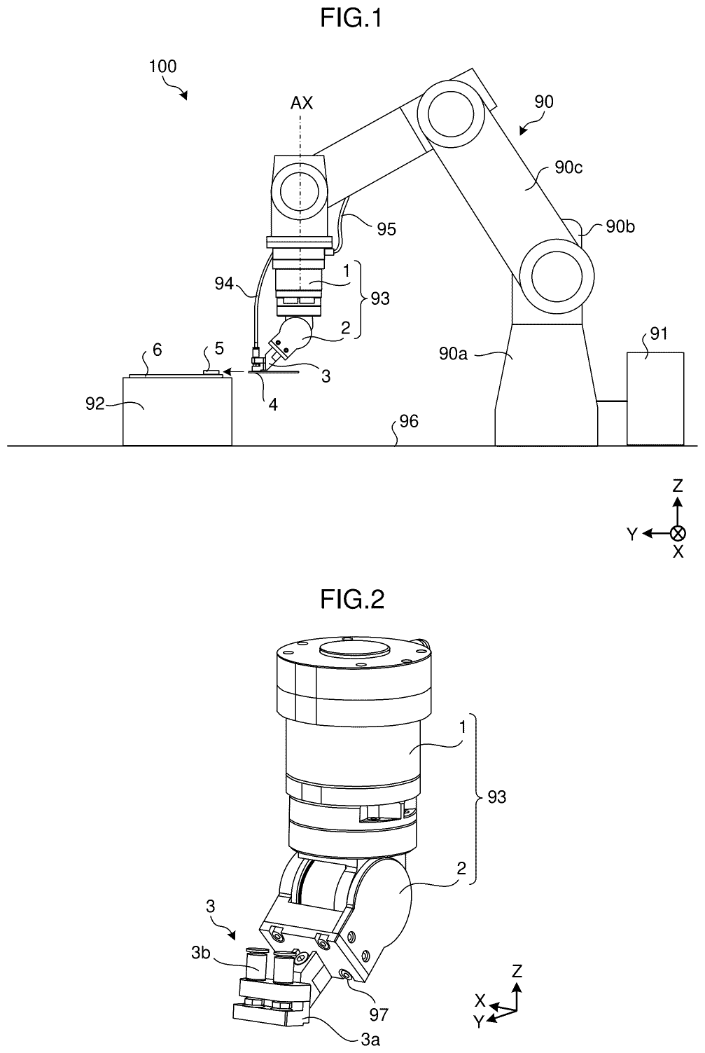

An assembly system that includes a connection jig according to an embodiment will be explained with reference to FIG. 1. As illustrated in FIG. 1, an assembly system 100 according to an embodiment includes a robot body part 90, a control device 91, a workbench 92, a connection jig 93, and air pipes 94, 95, etc. The robot body part 90 is an example of an automated transportation part that automatically transports a connection target such as a signal transmission medium with a plate shape to a predetermined position.

The robot body part 90 is an industrial robot and includes a base part 90a with a proximal end that is fixed on a mounting surface 96 such as floor, a pivot part 90b with a proximal end that is attached to a leading end of the base part 90a so as to be rotatable around a pivot axis as a center thereof, and an arm 90c with a proximal end that is attached to a leading end of the pivot part 90b so as to be rotatable. The arm 90c includes a plurality of links that are rotatable with respect to one another around rotation axes that are different from one another as centers thereof.

The robot body part 90 includes a non-illustrated motor that rotates the pivot part 90b around a pivot axis as a center thereof. Furthermore, the robot body part 90 includes a non-illustrated motor that rotates a link of the arm 90c around a rotation axis as a center thereof for each rotation axis.

Each motor that is provided in the robot body part 90 is controlled by the control device 91. Additionally, the robot body part 90 is, for example, a six-axis robot and may be a seven-or-more-axis robot or a five-or-less-axis robot.

A proximal end of the connection jig 93 is fixed on a leading end of the arm 90c. The connection jig 93 is provided with a proximal end that is fixed on a leading end of the arm 90c and a leading end that is fixed on a holding part 3 that holds a connection target 4. The connection jig 93 includes a position correction part 1 and a joining part 2. As illustrated in FIG. 2, the holding part 3 includes a body part 3a that attracts the connection target 4 and an air supply/discharge part 3b that is connected to an air pipe 94 (see FIG. 1) that supplies or discharges air to/from the body part 3a.

The connection target 4 as illustrated in FIG. 1 is a signal transfer medium with a plate shape. A signal transfer medium with a plate shape is, for example, a flexible substrate such as a flexible printed circuit (FPC) or a rigid substrate, etc. Additionally, the connection target 4 is not limited to a configuration as illustrated in FIG. 1 and may be, for example, an electrical connector where a cable, a flexible flat cable (FFC), or a cable part that has a plurality of cables is attached thereto, etc.

A circuit board 6 where a target to be connected 5 is attached thereto is fixed on the workbench 92. The target to be connected 5 is, for example, an electrical connector. The control device 91 preliminarily stores therein teaching data for causing the robot body part 90 to execute an operation that connects the connection target 4 to the target to be connected 5. The control device 91 controls each motor that is provided in the robot body part 90, based on stored teaching data, so as to move the connection jig 93 that holds the connection target 4 and connect the connection target 4 to the target to be connected 5.

Hereinafter, for the sake of explanatory convenience, a direction where the robot body part 90 moves the holding part 3 in order to connect the connection target 4 to the target to be connected 5 (a positive direction of a Y-axis) will be referred to as a “frontward direction” and an opposite direction thereof (a negative direction of a Y-axis) will be referred to as a “backward direction”. Furthermore, width directions of the connection target 4 (X-axis directions) will be referred to as “leftward and rightward directions” and height directions of the connection target 4 (Z-axis directions) will be referred to as “upward and downward directions”. Furthermore, a direction where the holding part 3 is rotated around an axis AX along upward and downward directions as a center thereof will be referred to as a “rotational direction”. Additionally, in a plurality of figures that include FIG. 2, XYZ axes in a case where a state of the assembly system 100 as illustrated in FIG. 1 is provided are illustrated supplementarily, so as to facilitate understanding thereof.

### 2. Configuration of Connection Jig 93

As illustrated in FIG. 2, the connection jig 93 includes a position correction part 1 with one end that is fixed on a leading end of the arm 90c (see FIG. 1) and a joining part 2 with one end that is fixed on another end of the position correction part 1 and another end that is attached to the holding part 3.

### 2.1. Configuration of Position Correction Part 1

The position correction part 1 is arranged between the robot body part 90 and the holding part 3 and corrects a position of the holding part 3. Such a position correction part 1 is also called a floating unit.

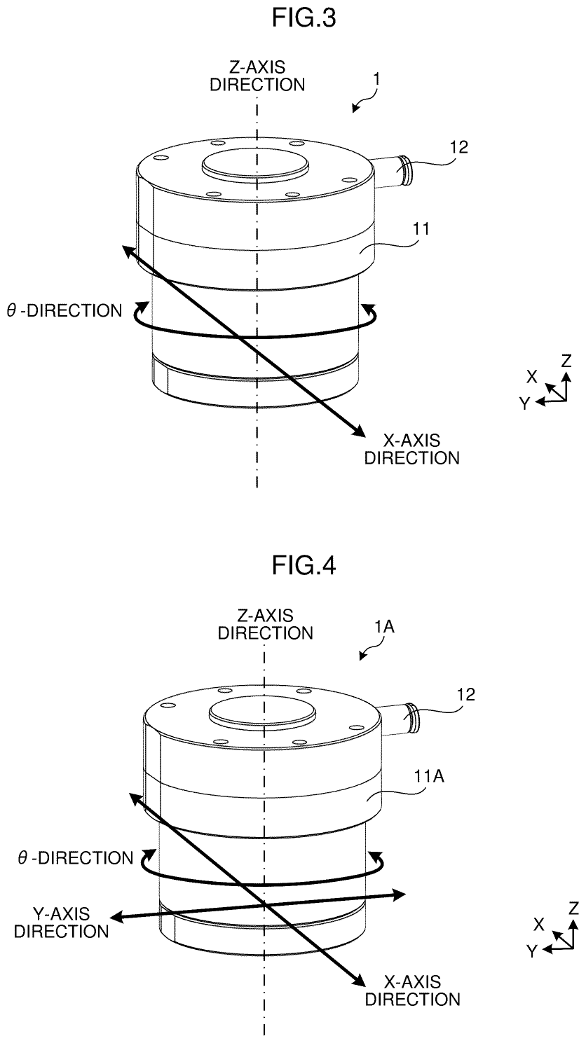

As illustrated in FIG. 3, the position correction part 1 is capable of reciprocating the holding part 3 in leftward and rightward directions (X-axis directions) where a neutral position of leftward and rightward directions (X-axis directions) is a center thereof, and further, is capable of reciprocating the holding part 3 in rotation directions where a neutral position of rotation directions is a center thereof.

Hence, the position correction part 1 moves the holding part 3 in leftward and rightward directions (X-axis directions) in a case where a force in leftward and rightward directions (X-axis directions) acts on the holding part 3, and moves the holding part 3 in rotation directions in a case where a force in rotation directions acts on the holding part 3.

Thereby, it is possible for the position correction part 1 to correct an error in alignment according to teaching data accurately in a case such an error in alignment according to teaching data is caused, that is, in a case where an error in a position of the connection target 4 that is moved by the robot body part 90 with respect to the target to be connected 5 is caused.

The position correction part 1 includes a body part 11 that corrects the holding part 3 in leftward and rightward directions (X-axis directions) and rotation directions and an air supply/discharge part 12 that is connected to the air pipe 95 that supplies/discharges air to/from an inside of the body part 11.

The body part 11 of the position correction part 1 is provided in a floating state where correction of a position of the holding part 3 is executed, in a case where air is not supplied through the air pipe 95 (see FIG. 1) and the air supply/discharge part 12. The position correction part 1 in a case where it is provided in a floating state moves the holding part 3 in leftward and rightward directions (X-axis directions) in a case where a force in leftward and rightward directions (X-axis directions) acts on the holding part 3, and moves the holding part 3 in rotation directions in a case where a force in rotation directions acts on the holding part 3.

Furthermore, the body part 11 of the position correction part 1 transfers from a floating state where correction of a position of the holding part 3 is executed to a lock state where a position of the holding part 3 is not corrected, in a case where air is supplied thereto through the air pipe 95 (see FIG. 1) and the air supply/discharge part 12.

In a case where a state of the position correction part 1 is a lock state, the holding part 3 is not moved in leftward and rightward directions (X-axis directions) or rotation directions, even in a case where a force in leftward and rightward directions (X-axis directions) acts on the holding part 3 or a force in rotation directions acts on the holding part 3.

Furthermore, the connection jig 93 may have a position correction part 1A as illustrated in FIG. 4, instead of the position correction part 1. A body part 11A of the position correction part 1A has a configuration that is capable of reciprocating the holding part 3 in frontward and backward directions (Y-axis directions) where a neutral position in frontward and backward directions (Y-axis directions) is a center thereof, in addition to leftward and rightward directions (X-axis directions) and rotation directions.

In such a case, it is possible for the position correction part 1A to move the holding part 3 in at least one of leftward and rightward directions (X-axis directions), frontward and backward directions (Y-axis directions), and rotation directions, in a case where an error in alignment according to teaching data is caused, that is, in a case where an error in alignment of the connection target 4 that is moved by the robot body part 90 with respect to the target to be connected 5 is caused. Therefore, it is possible to correct an error in alignment according to teaching data accurately.

For example, the position correction part 1A in a case where it is provided in a floating state moves the holding part 3 in frontward and backward directions (Y-axis directions) in a case where a force in frontward and backward directions (Y-axis directions) acts on the holding part 3. Additionally, the position correction part 1A in a case where air is supplied thereto through the air pipe 95 (see FIG. 1) and the air supply/discharge part 12 so as to be provided in a lock state does not move the holding part 3 in frontward and backward directions (Y-axis directions), even if a force in frontward and backward directions (Y-axis directions) acts on the holding part 3.

### 2.2 Configuration of Joining Part 2

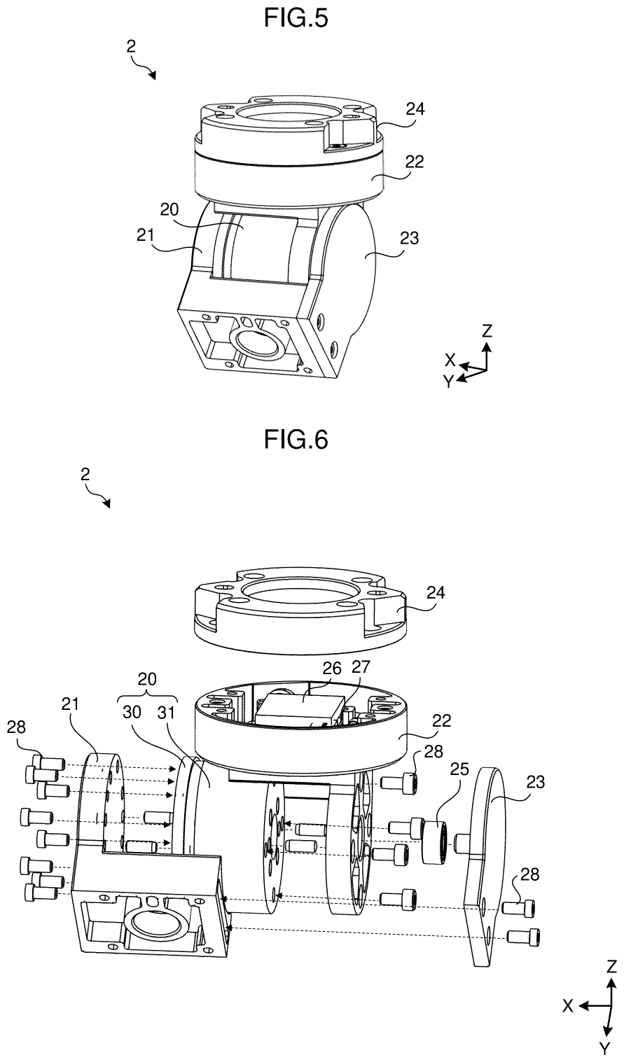

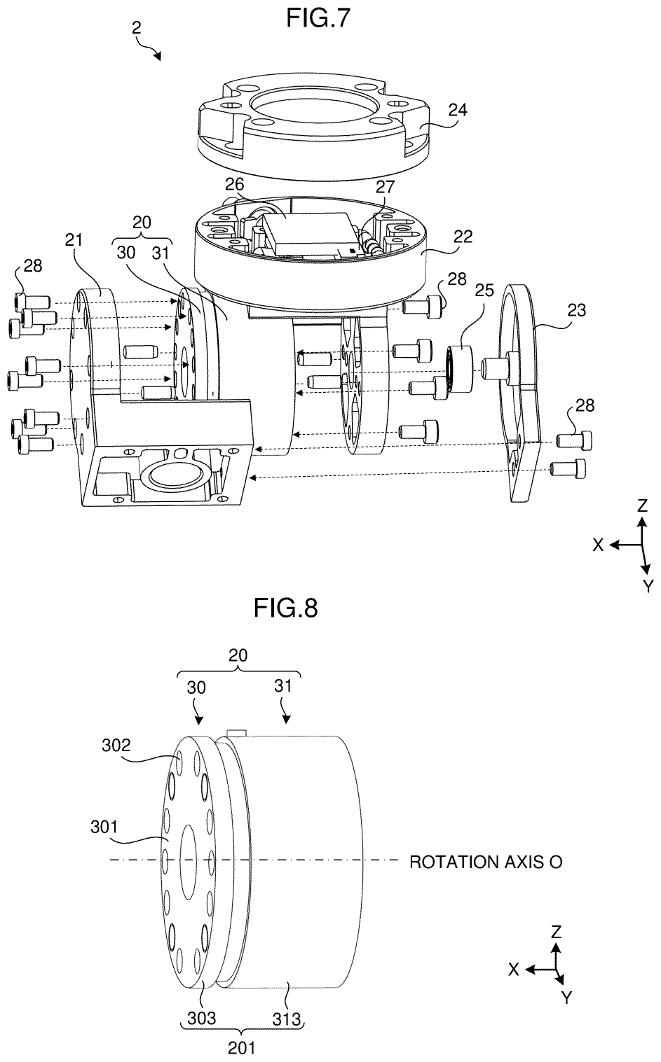

As illustrated in FIG. 5 to FIG. 7, the joining part 2 includes a sensor 20, a first joining part 21, a second joining part 22, a third joining part 23, and a fourth joining part 24. Moreover, as illustrated in FIG. 6 and FIG. 7, the joining part 2 includes a bearing part 25, a circuit board 26, a wiring member 27, and a plurality of attachments 28. Such an attachment 28 is, for example, a bolt, and may be, a screw, a knock pin, etc.

The first joining part 21 and the third joining part 23 are fixed by the plurality of attachments 28. Furthermore, the first joining part 21 is fixed on a passive part 30 of the sensor 20 by the plurality of attachments 28, and the holding part 3 is fixed by a non-illustrated fixture. Furthermore, a fixation part 31 of the sensor 20 is fixed on the second joining part 22 by the plurality of attachments 28. Then, the third joining part 23 is supported on the second joining part 22 through the bearing part 25 so as to be rotatable.

Thereby, it is possible for the joining part 2 to convert a force that is applied to the holding part 3 to a force in a direction that is capable of being detected by the sensor 20 (to a force around a rotation axis O as described later) accurately in a case where such a force is applied to the holding part 3. Hence, it is possible for the connection jig 93 to execute connection between the connection target 4 and the target to be connected 5 accurately. Hereinafter, a configuration of the joining part 2 will be explained specifically.

### 2.2.1. Configuration of Sensor 20

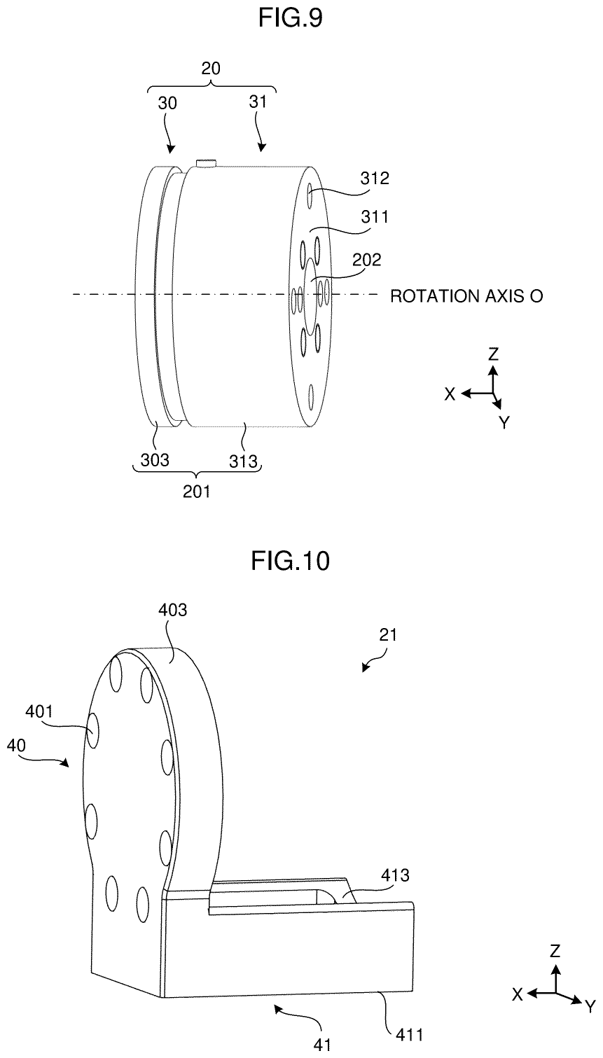

As illustrated in FIG. 8 and FIG. 9, in the sensor 20, a passive part 30 is arranged on one end thereof in a direction of a rotation axis O and a fixation part 31 is arranged on another end thereof, so that a force around a rotation axis O to the passive part 30 is detected. It is also possible to represent a force around a rotation axis O as a torque.

For example, in a case where the connection jig 93 is provided in a state of FIG. 1, a direction of a rotation axis O is an X-axis direction, and in the sensor 20, the passive part 30 is arranged on one end in an X-axis direction and the fixation part 31 is arranged on another end, so that a force around an X-axis to the passive part 30 is detected.

Furthermore, as illustrated in FIG. 8 and FIG. 9, in the sensor 20, an end surface 301 of the passive part 30 is a flat surface and an end surface 311 of the fixation part 31 is a flat surface. Then, the end surface 301 of the passive part 30 and the end surface 311 of the fixation part 31 are parallel to one another.

Furthermore, the sensor 20 is formed into a hollow-cylindrical shape where a rotation axis O is provided as an axis line thereof. An outer peripheral surface 201 of the sensor 20 is formed into a hollow-cylindrical surface shape. The outer peripheral surface 201 includes an outer peripheral surface 303 with a hollow-cylindrical shape for the passive part 30 and an outer peripheral surface 313 with a hollow-cylindrical shape for the fixation part 31. The outer peripheral surface 303 and the outer peripheral surface 313 have identical diameters where such an example is not limitative.

Furthermore, the sensor 20 is formed into a hollow shape and an inner peripheral surface 202 of the sensor 20 is formed into a hollow-cylindrical surface shape. Apertures that are continuous with the inner peripheral surface 202 are formed at centers of the end surfaces 301, 311.

A plurality of attachment holes 302 where the plurality of attachments 28 are attached thereto are formed on the end surface 301 of the passive part 30 in the sensor 20, and similarly, a plurality of attachment holes 312 where the plurality of attachments 28 are attached thereto are also formed on the end surface 311 of the fixation part 31 in the sensor 20.

Additionally, a shape of the sensor 20 is not limited to a hollow-cylindrical shape where a rotation axis O is provided as an axis line thereof, and it may be formed into, for example, a solid-cylindrical shape where a rotation axis O is provided as an axis line thereof. Furthermore, the sensor 20 is a torque sensor that detects a moment around a rotation axis O to the passive part 30, and is not limited to such a torque sensor as long as it is a sensor that is capable of detecting a force around a rotation axis O.

Additionally, the sensor 20 is a sensor that detects a force around a rotation axis O from a change of an electrostatic capacitance that is changed depending on a rotation angle around a rotation axis O of the passive part 30 with respect to the fixation part 31, and may be, for example, a sensor that uses a strain gauge, a sensor that uses a piezoelectric element, a sensor that utilizes a magnetostrictive effect or an inverse-magnetostrictive effect, a sensor that utilizes electromagnetic induction, etc., as long as it has a configuration that detects a force around a rotation axis O.

### 2.2.2. Configuration of First Joining Part 21

As illustrated in FIG. 5 to FIG. 7, the first joining part 21 is arranged between the passive part 30 of the sensor 20 and the holding part 3, and joins the passive part 30 of the sensor 20 and the holding part 3.

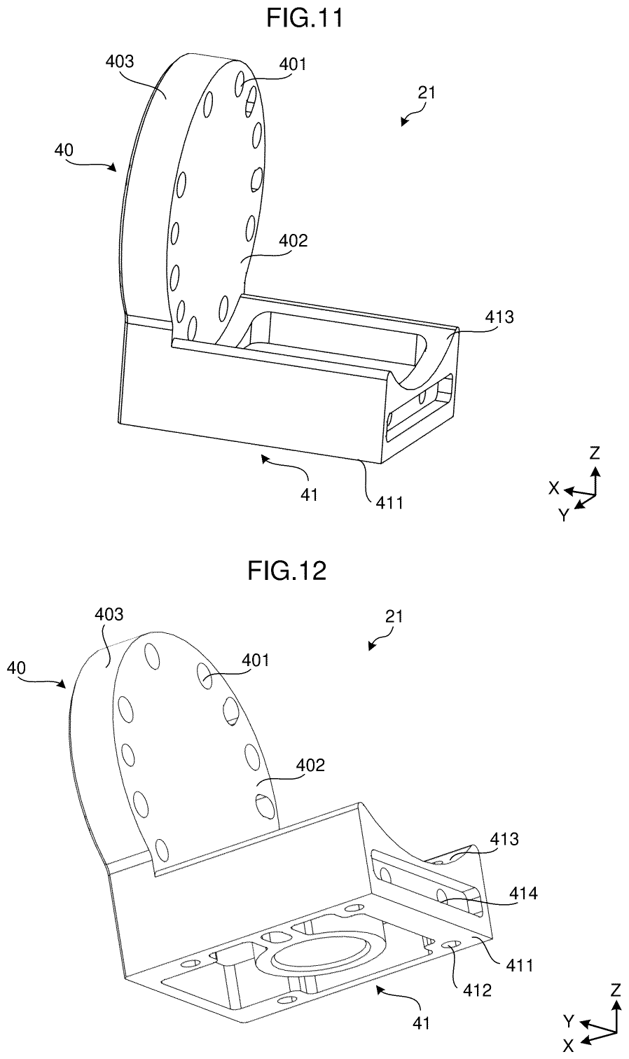

As illustrated in FIG. 10 and FIG. 11, the first joining part 21 includes an attachment part 40 that is fixed on the passive part 30 (see FIG. 6 and FIG. 7) of the sensor 20, and a support part 41 that fixes the holding part 3 thereon and supports the holding part 3 (see FIG. 2).

A plurality of attachment holes 401 where the plurality of attachments 28 (see FIG. 6 and FIG. 7) are attached thereto are formed on the attachment part 40. The plurality of attachments 28 are attached to the plurality of attachment holes 401 on the attachment part 40 and the attachment holes 302 on the passive part 30 of the sensor 20 as a bridge therebetween, so that the attachment part 40 is fixed on the passive part 30 of the sensor 20.

Furthermore, the attachment part 40 has an attachment surface 402 (see FIG. 11 and FIG. 12) that contacts the end surface 301 (see FIG. 8) of the passive part 30 in the sensor 20 in a case where the attachment part 40 is fixed on the passive part 30 in the sensor 20. The attachment surface 402 is a flat surface that is similar to the end surface 301 of the passive part 30. Additionally, as long as the attachment part 40 is fixed on the passive part 30, a gap may be provided between the attachment surface 402 of the attachment part 40 and the end surface 301 of the passive part 30.

Furthermore, a shape of a side surface 403 of the attachment part 40 when viewed from an X-axis direction is a hollow-cylindrical shape with a diameter that is identical to that of the outer peripheral surface 201 of the sensor 20 and may be a diameter that is different from a diameter of the outer peripheral surface 201 of the sensor 20.

The support part 41 has an attachment surface 411 where the holding part 3 is attached thereto, a plurality of attachment holes 412, an opposite surface 413 with a concave shape that is opposite with the outer peripheral surface 201 of the sensor 20, and a plurality of attachment holes 414 where the plurality of attachments 28 (see FIG. 6 and FIG. 7) are attached thereto.

The plurality of attachments 97 (see FIG. 2) are attached to the plurality of attachment holes 412 and a plurality of attachment holes that are formed on the holding part 3 as a bridge therebetween, so that the holding part 3 is fixed on the support part 41 in a state where a part of the holding part 3 contacts the attachment surface 411. Such an attachment 97 is, for example, a bolt, and may be a screw, etc.

The opposite surface 413 is a surface on an opposite side of the attachment surface 411 and is a curved surface with a concave shape that has a radius of curvature that is slightly greater than that of the outer peripheral surface 201 of the sensor 20. For example, the opposite surface 413 has a radius of curvature that is greater than that of the outer peripheral surface 201 by a length of a gap G1 as illustrated in FIG. 13.

In a state where the attachment part 40 is fixed on the passive part 30 of the sensor 20, the outer peripheral surface 201 of the sensor 20 and the opposite surface 413 of the support part 41 are opposite with one another through a gap G1 as illustrated in FIG. 13, so that the outer peripheral surface 201 of the sensor 20 and the opposite surface 413 of the support part 41 do not contact one another and hence no friction resistance is caused between the sensor 20 and the first joining part 21. Thereby, in the connection jig 93, it is possible for the sensor 20 to execute accurate detection.

### 2.2.3. Configuration of Second Joining Part 22

As illustrated in FIG. 5 to FIG. 7, the second joining part 22 is arranged between the fixation part 31 of the sensor 20 and the fourth joining part 24 and joins the fixation part 31 of the sensor 20 and the fourth joining part 24.

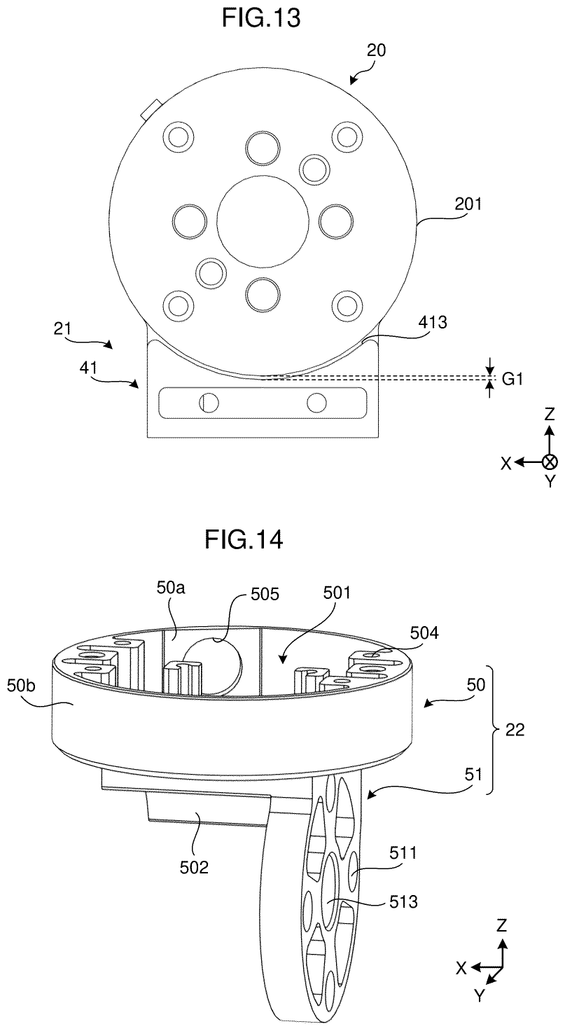

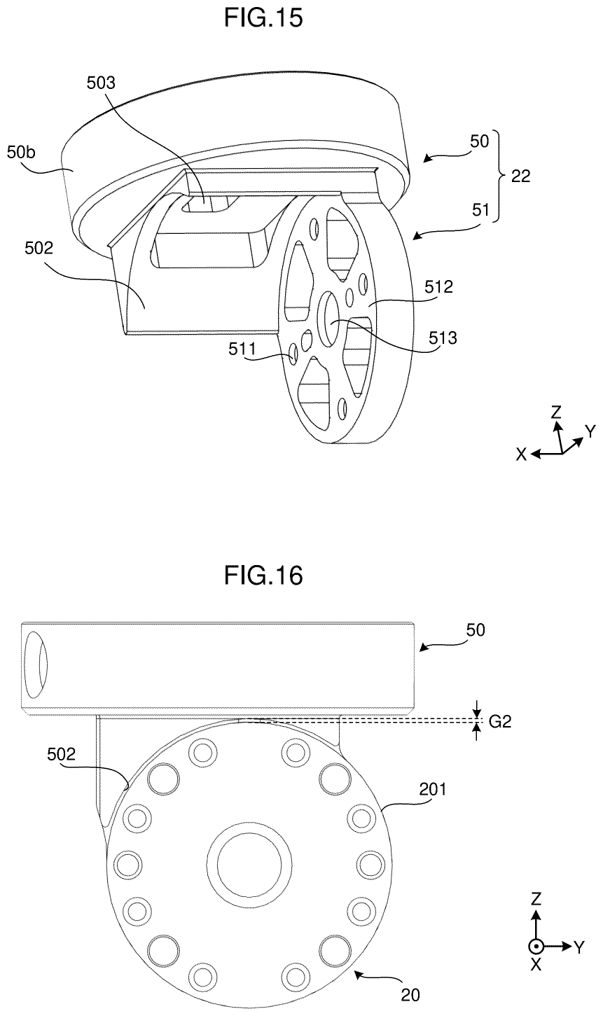

As illustrated in FIG. 14 and FIG. 15, the second joining part 22 includes a body part 50 that houses the circuit board 26 (see FIG. 6 and FIG. 7), etc., and a support part 51 where the fixation part 31 of the sensor 20 is fixed thereon so as to support the fixation part 31 of the sensor 20.

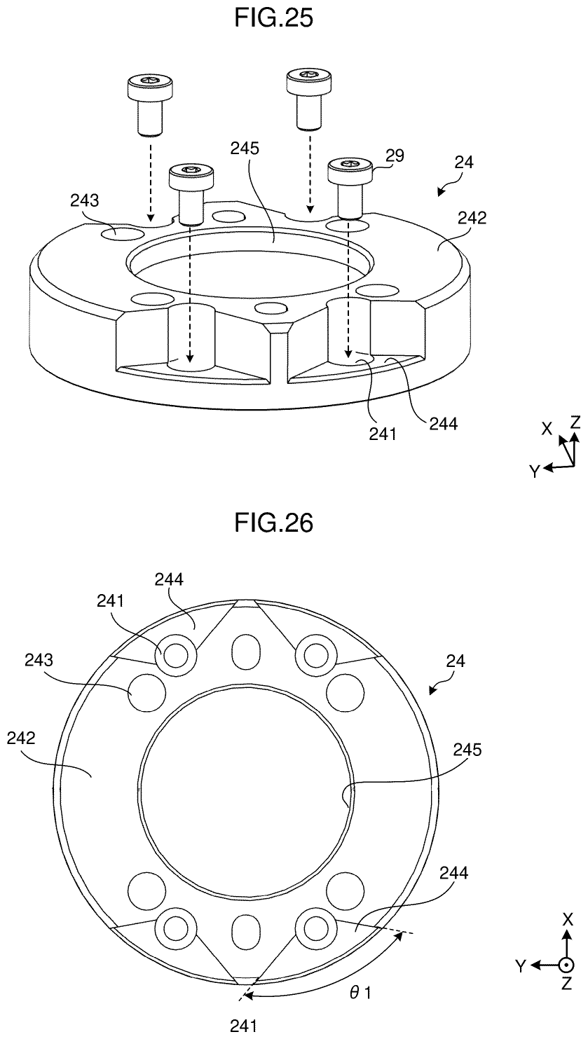

The body part 50 has a housing space 501 that houses the circuit board 26, etc., an opposite surface 502 with a concave shape that is opposite with the outer peripheral surface 201 of the sensor 20, and a plurality of attachment holes 504 where a plurality of attachments 29 (see FIG. 25) are attached thereto. The housing space 501 is formed by an inner surface 50a with a bowl shape for the body part 50. Such an attachment 29 is, for example, a bolt, and may be a screw, a knock pin, etc.

The opposite surface 502 is formed on an outer surface 50b of the body part 50 and has a radius of curvature that is slightly greater than that of the outer peripheral surface 201 of the sensor 20. For example, the opposite surface 502 has a radius of curvature that is greater than that of the outer peripheral surface 201 of the sensor 20 by a length of a gap G2 as illustrated in FIG. 16.

In a state where the fixation part 31 of the sensor 20 is fixed on the support part 51, the outer peripheral surface 201 of the sensor 20 and the opposite surface 502 of the body part 50 are opposite with one another through a gap G2 as illustrated in FIG. 16, so that the outer peripheral surface 201 of the sensor 20 and the opposite surface 502 of the body part 50 do not contact one another. Hence, no friction resistance between the sensor 20 and the second joining part 22 is caused. Thereby, in the connection jig 93, it is possible for the sensor 20 to execute accurate detection.

Furthermore, an insertion port 503 (see FIG. 15) where a wiring member with one end that is connected to the sensor 20 is inserted through the housing space 501 is formed on the body part 50, and another end of such a wiring member is connected to the circuit board 26 that is arranged in the housing space 501.

Furthermore, an insertion port 505 (see FIG. 14) where a wiring member with one end that is connected to the circuit board 26 is inserted through an outside of the connection jig 93 is formed on the body part 50, and another end of such a wiring member is connected to the control device 91.

The support part 51 is continuous with the body part 50 and extends in a downward direction (a negative direction of a Z-axis) that is a direction away from the outer surface 50b of the body part 50. A plurality of attachment holes 511 where the plurality of attachments 28 (see FIG. 6 and FIG. 7) are attached thereto are formed on the support part 51. The plurality of attachments 28 are attached to the plurality of attachment holes 511 on the support part 51 and the plurality of attachment holes 312 on the fixation part 31 of the sensor 20 as a bridge therebetween, so that the fixation part 31 of the sensor 20 is fixed on the support part 51.

Furthermore, the support part 51 has an attachment surface 512 that contacts the end surface 311 (see FIG. 9) of the fixation part 31 in the sensor 20 in a case where the fixation part 31 in the sensor 20 is fixed on the support part 51. The attachment surface 512 is a flat surface that is similar to the end surface 311 of the fixation part 31. Additionally, as long as the fixation part 31 is attached to the support part 51, a gap may be provided between the end surface 311 of the fixation part 31 and the attachment surface 512 of the support part 51.

Furthermore, an attachment hole 513 where the bearing part 25 is attached thereto is formed on the support part 51. The attachment hole 513 is a hole that is formed by a hollow-cylindrical surface that is an inner peripheral surface. An outer peripheral surface of the bearing part 25 contacts a hollow-cylindrical surface of the attachment hole 513, so that the bearing part 25 is arranged in the attachment hole 513 and hence the bearing part 25 is attached to the support part 51.

### 2.2.4. Configuration of Third Joining Part 23

As illustrated in FIG. 5 to FIG. 7, the third joining part 23 is joined to the first joining part 21 and is supported by the second joining part 22 in a rotatable manner around a rotation axis O (see FIG. 8). The third joining part 23 is supported by the second joining part 22 through the bearing part 25 in a state where a part of the second joining part 22 is interposed between it and the fixation part 31 of the sensor 20.

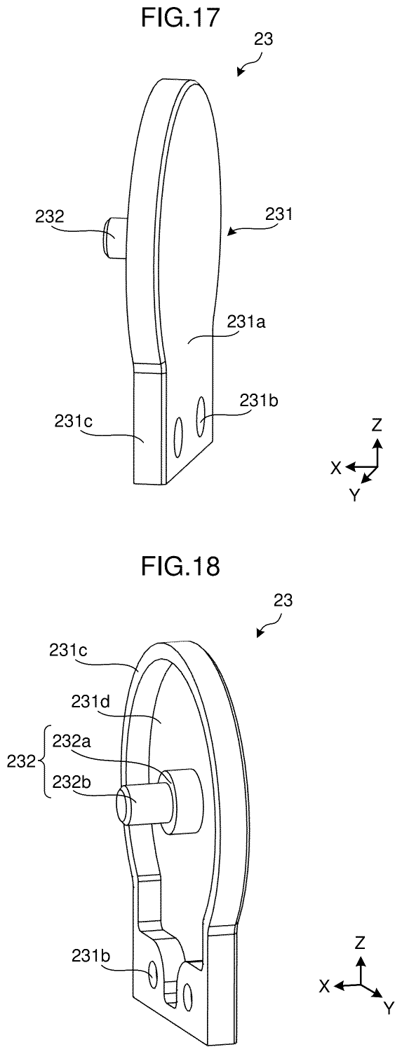

As illustrated in FIG. 17 and FIG. 18, the third joining part 23 includes a cover part 231 that covers the sensor 20 from a direction of a rotation axis O of the sensor 20 (an X-axis direction) and a shaft part 232 that is attached to the bearing part 25.

As illustrated in FIG. 17, the cover part 231 includes a panel surface 231a that covers the attachment holes 511, 513 (see FIG. 14) of the support part 51 in the second joining part 22 from an outside thereof, and a plurality of attachment holes 231b that is formed on the panel surface 231a where the plurality of attachments 28 (see FIG. 6 and FIG. 7) are attached thereto.

Moreover, as illustrated in FIG. 18, the cover part 231 includes a side wall 231c that extends in an extension direction of the shaft part 232 from an outer edge of the panel surface 231a (see FIG. 17), and a recessed part 231d that is surrounded by the side wall 231c. In the cover part 231, thinning of the cover part 231 is executed by the recessed part 231d, so that it is possible to attain weight reduction of the cover part 231.

The shaft part 232 has a first protrusion part 232a with a solid-cylindrical shape that protrudes from an area of the recessed part 231d in a direction that is orthogonal to the panel surface 231a, and a second protrusion part 232b with a solid cylindrical shape that is continuous with a leading end of the first protrusion part 232a and protrudes in a direction that is similar to that of the first protrusion part 232a so as to be coaxial with a central axis of the first protrusion part 232a. An outer diameter of the second protrusion part 232b is less than an outer diameter of the first protrusion part 232a.

The plurality of attachments 28 (see FIG. 6 and FIG. 7) are attached to the plurality of attachment holes 231b on the third joining part 23 and the plurality of attachment holes 414 on the first joining part 21 as a bridge therebetween, so that the third joining part 23 is attached to the first joining part 21 as illustrated in FIG. 2.

The shaft part 232 is supported by the second joining part 22 through the bearing part 25 so as to rotatable. Thereby, the holding part 3 is supported by the second joining part 22 through the third joining part 23 so as to be rotatable and is supported by the second joining part 22 through the first joining part 21 and the sensor 20 so as to rotatable. A rotation axis of the bearing part 25 is arranged at a position where it is coaxial with a rotation axis O of the sensor 20.

### 2.2.5. Configuration of Bearing Part 25

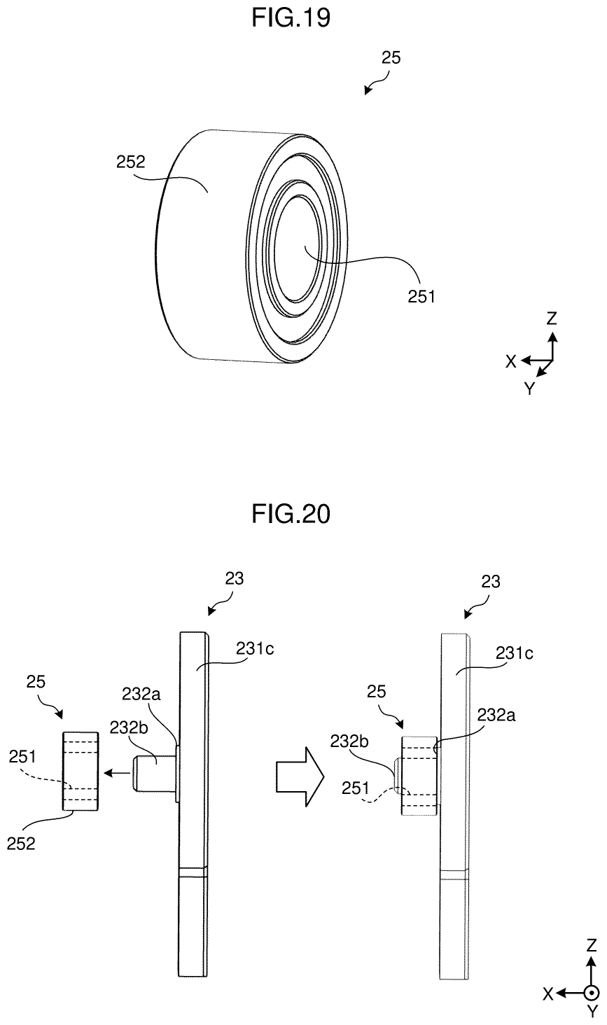

As illustrated in FIG. 19, the bearing part 25 includes an outer ring 252, an inner ring 251, and a plurality of non-illustrated rolling elements that are arranged between the outer ring 252 and the inner ring 251. Such a bearing part 25 is a rolling-bearing-type bearing, is not limited to such an example, and may be a plain-bearing-type bearing.

As illustrated in FIG. 20, the inner ring 251 of the bearing part 25 is inserted into the second protrusion part 232b of the shaft part 232 in the third joining part 23 and contacts the first protrusion part 232a of the shaft part 232. Positioning of the bearing part 25 in an insertion direction (an X-axis direction) for the shaft part 232 is executed by contacting the first protrusion part 232a of the shaft part 232.

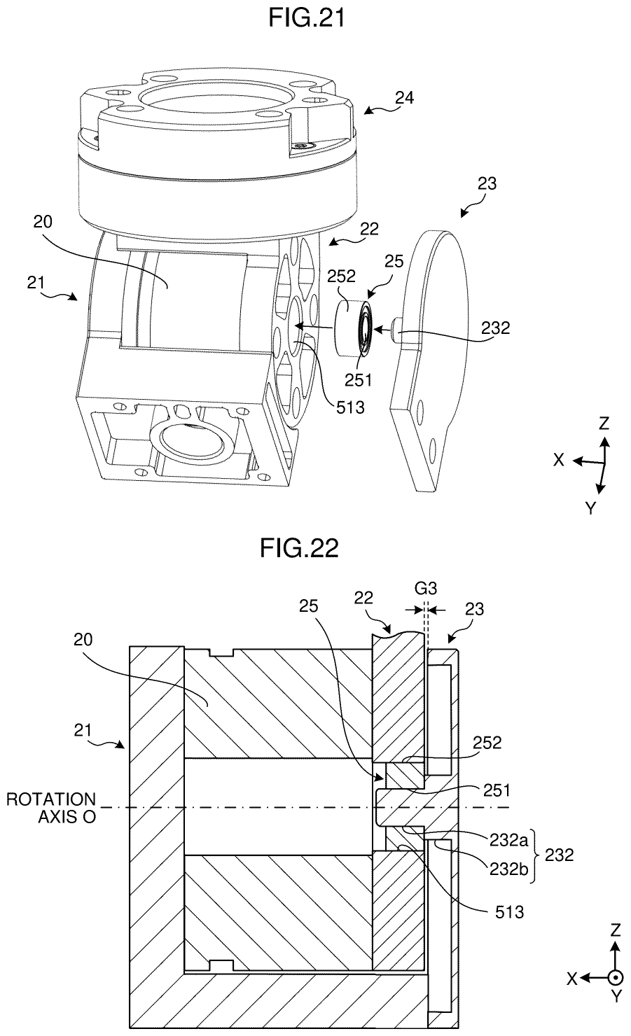

Furthermore, as illustrated in FIG. 21 and FIG. 22, the outer ring 252 of the bearing part 25 is inserted into the attachment hole 513 of the second joining part 22, so as to be attached to the attachment hole 513 of the second joining part 22. Thereby, a rotation axis of the bearing part 25 is arranged at a position where it is coaxial with a rotation axis O of the sensor 20.

The inner ring 251 of the bearing part 25 is attached to the second protrusion part 232b of the shaft part 232 by inserting the second protrusion part 232b of the shaft part 232 thereinto, and the outer ring 252 of the bearing part 25 is attached to the attachment hole 513 of the second joining part 22 by being inserted into the attachment hole 513 of the second joining part 22. Additionally, the outer ring 252 of the bearing part 25 may be attached to the attachment hole 513 of the second joining part 22 by an adhesive material, etc.

As illustrated in FIG. 20, the first protrusion part 232a protrudes in a positive direction of an X-axis from an area that is surrounded by the side wall 231c, so that movement of the bearing part 25 in a negative direction of an X-axis is restricted by the first protrusion part 232a.

Hence, as illustrated in FIG. 22, a gap G3 is formed between the second joining part 22 and the third joining part 23, except an area of the shaft part 232 of the third joining part 23. Thereby, the second joining part 22 and the third joining part 23 do not contact one another, so that no friction resistance between the second joining part 22 and the third joining part 23 is caused. Thereby, in the connection jig 93, it is possible for the sensor 20 to execute accurate detection.

Thereby, in a case where a force is applied to the holding part 3, it is possible for the joining part 2 to convert such a force that is applied to the holding part 3 to a force around a rotation axis O that is a force in a direction that is capable of being detected by the sensor 20 accurately. Hence, it is possible for the connection jig 93 to execute connection between the connection target 4 and the target to be connected 5 accurately.

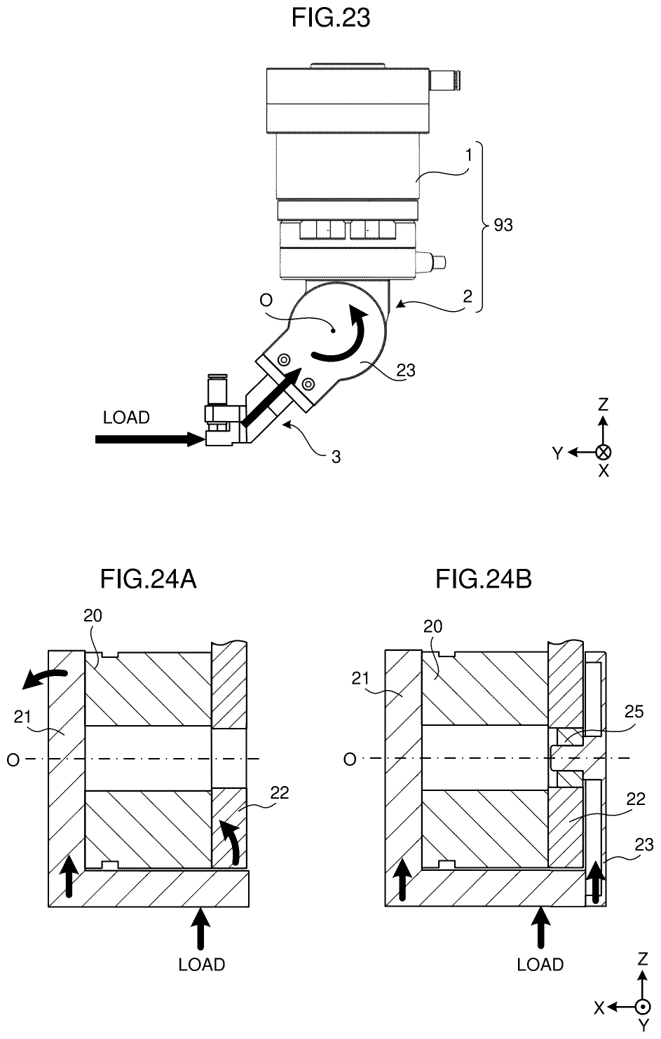

Furthermore, as described above, the third joining part 23 is supported by the second joining part 22 through the bearing part 25 so as to be rotatable. Thereby, as illustrated in FIG. 23, in a case where a force is applied to the holding part 3, it is possible for the joining part 2 to convert such a force that is applied to the holding part 3 to a force in a direction that is capable of being detected by the sensor 20 (a force around rotation axis O) accurately.

For example, as illustrated in FIG. 24A, in a case where the third joining part 23 is not provided, a force other than a force around a rotation axis O is applied to the sensor 20, depending on a direction or position where a load is applied thereto.

On the other hand, as illustrated in FIG. 24B, the connection jig 93 according to an embodiment has the third joining part 23 that is supported by the second joining part 22 through the bearing part 25 so as to be rotatable, so that, even in a case where a load other than a force around a rotation axis O is applied to the first joining part 21, it is possible to convert such a load to such a force around a rotation axis O accurately. Thereby, it is possible for the connection jig 93 to execute connection between the connection target 4 and the target to be connected 5 accurately.

### 2.2.6. Configuration of Fourth Joining Part 24

The fourth joining part 24 is arranged between the first joining part 21 (see FIG. 5 to FIG. 7) and the position correction part 1 (see FIG. 2) and joins the first joining part 21 and the position correction part 1. Additionally, the fourth joining part 24 may be included in the second joining part 22.

As illustrated in FIG. 25, the fourth joining part 24 includes a plurality of attachment holes 241 where the plurality of attachments 29 are attached thereto, a contact surface 242 that contacts a leading end of the position correction part 1, a plurality of attachment holes 243 where a plurality of non-illustrated attachments that join the fourth joining part 24 and a leading end of the arm 90c are inserted therethrough, a plurality of groove parts 244 where a non-illustrated tool for rotating and attaching the attachments 29 (for example, a minor axis short hexagonal wrench) thereto is inserted thereinto, and an aperture part 245 that is provided in a central area of the contact surface 242.

The plurality of attachments 29 are attached to the plurality of attachment holes 241 on the fourth joining part 24 and the plurality of attachment holes 504 on the second joining part 22 as a bridge therebetween, so that the second joining part 22 is fixed on the fourth joining part 24.

Each groove part 244 is formed into a fan shape in a direction that is orthogonal to a joining direction for the second joining part 22 and the fourth joining part 24 (a Z-axis direction in FIG. 1), so as to allow rotation of a handle of a non-illustrated tool around a head of a non-illustrated tool that rotates such an attachment 29 as a center thereof.

In an example as illustrated in FIG. 26, the groove part 244 provides an allowed rotation angle θ1 of a non-illustrated tool around a head as a center thereof that is 120 degrees at a maximum and is not limited to such an example where such an allowed rotation angle θ1 of a tool may be provided, for example, within a range of 100 degrees to 130 degrees.

The joining part 2 is configured to insert a plurality of non-illustrated attachments through the plurality of attachment holes 243 so as to join the fourth joining part 24 and a leading end of the position correction part 1, and subsequently attach the second joining part 22 to the fourth joining part 24 by the attachments 29. Hence, for the fourth joining part 24, it is possible to attain height reduction of the fourth joining part 24 while workability is improved, and eventually, attain downsizing of the joining part 2.

### 3. Connection Step by Assembly System 100

Next, a connection step for a connection target 4 to a target to be connected 5 by an assembly system 100 will be explained. A control device 91 (see FIG. 1) controls each motor that is provided in a robot body part 90 (see FIG. 1) based on stored teaching data, so as to move a connection jig 93 that holds the connection target 4 and connect the connection target 4 to the target to be connected 5.

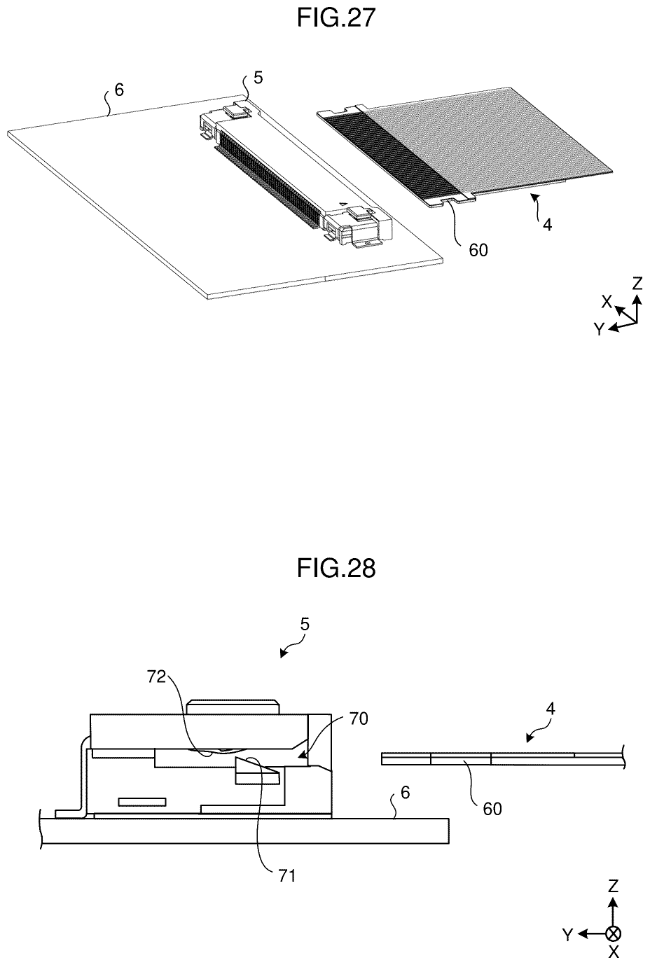

In an example as illustrated in FIG. 27 and FIG. 28, the connection target 4 is a flexible printed circuit (FPC) and the target to be connected 5 is an electrical connector. As illustrated in FIG. 27, a lock groove 60 that has a concave shape in a direction (an X-axis direction) that is orthogonal to an insertion direction (a positive direction of a Y-axis) to the target to be connected 5 is formed on the connection target 4, and the target to be connected 5 includes a lock part 71 for locking the lock groove 60 and a plurality of electrically conductive contacts 72.

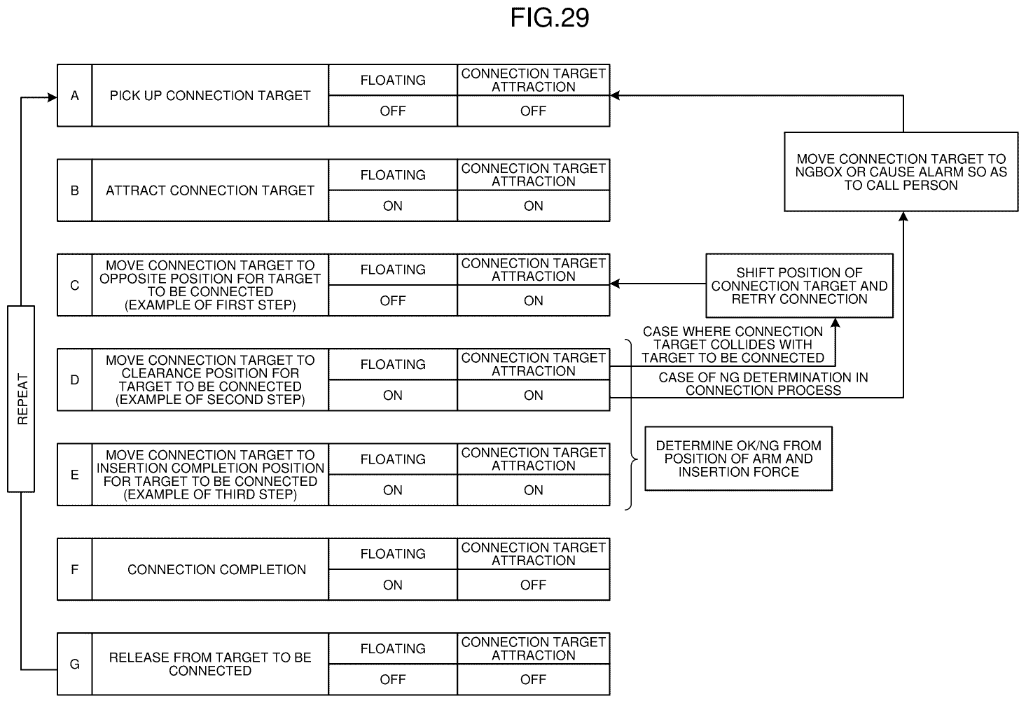

As illustrated in FIG. 29, the control device 91 (see FIG. 1) controls the robot body part 90 (see FIG. 1) so as to execute a step A that moves the connection jig 93 so as to move the connection target 4 to a position of a non-illustrated connection target supply device. A connection target supply device is a device that supplies the connection target 4 thereto and a position of such a connection target supply device is an example of a supply position where the connection target 4 is supplied thereto.

At step A, floating for a position correction part 1 is OFF, that is, it is provided in a lock state, and attraction for the holding part 3 is OFF. In FIG. 29, as a connection target attraction is OFF, it means that attraction for the holding part 3 is OFF.

Then, the control device 91 executes step B that executes suction of air in an air pipe 94 for the holding part 3, so that the connection target 4 that is supplied from a non-illustrated connection target supply device is attracted on the holding part 3. At step B, floating is ON, so that the holding part 3 is provided in a floating state, and further, connection target attraction is ON, so that the connection target 4 is attracted on the holding part 3.

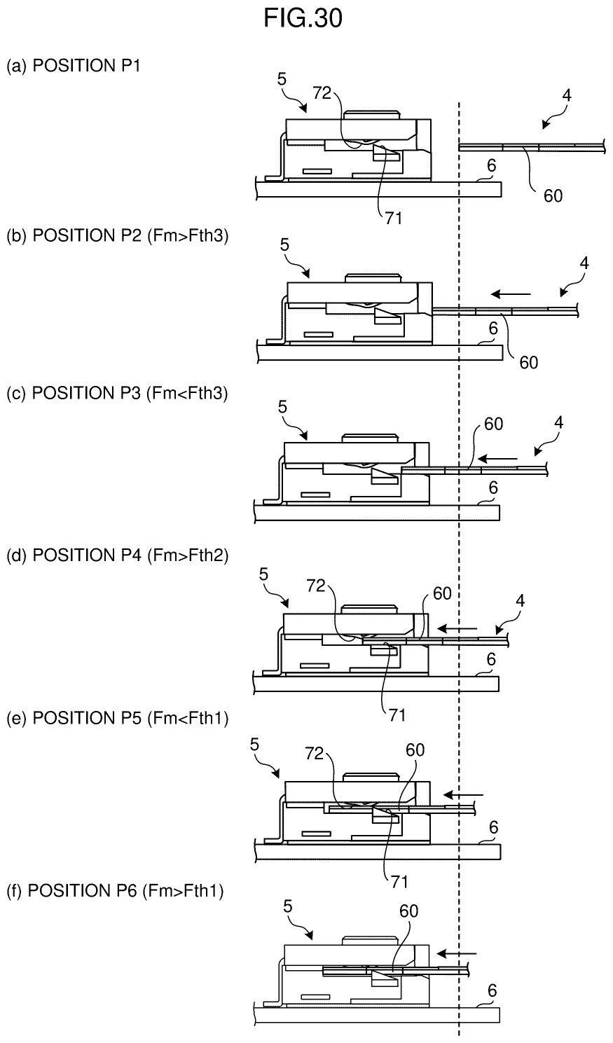

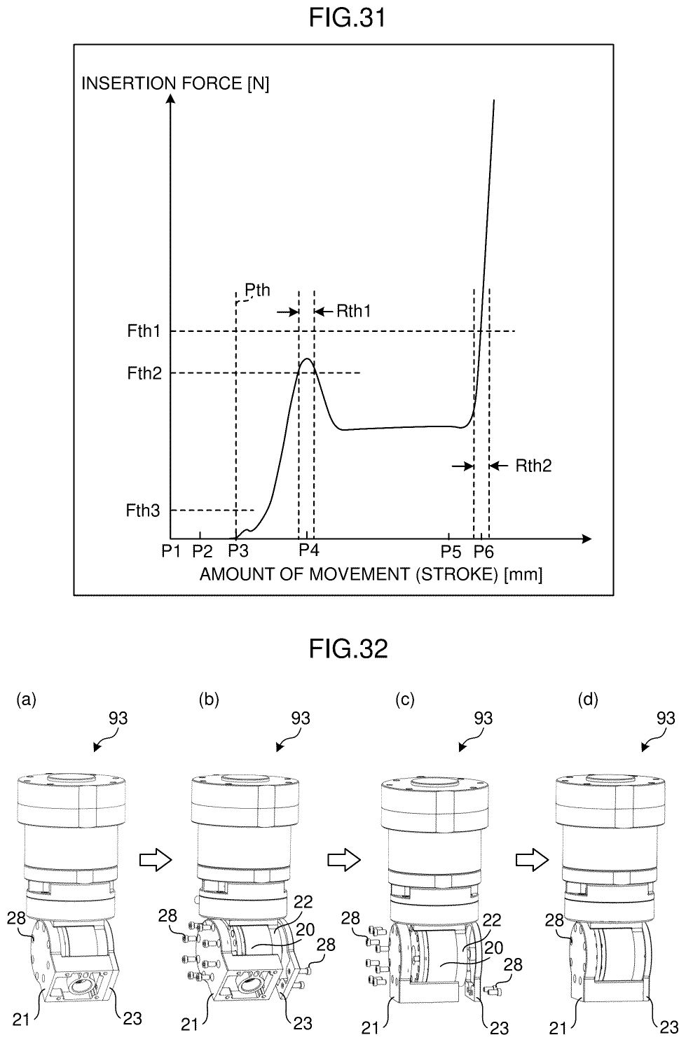

Then, as illustrated in FIG. 29, the control device 91 controls the robot body part 90 so as to execute step C that moves the connection jig 93 that holds the connection target 4 and arranges the connection target 4 at a position that is opposite with the target to be connected 5 from a position of a connection target supply device. Step C is an example of a first step that includes a transportation step that transports the connection target 4. Furthermore, a position that is opposite with the target to be connected 5 is a position that is opposite with an aperture 70 of the target to be connected 5 in a Y-axis direction, and is an example of a position where step D is started. In FIG. 30 and FIG. 31, a position that is opposite with the target to be connected 5 is indicated by position P1.

At step C, floating is OFF, so that the holding part 3 is provided in a lock state and changing of a positional relationship between the connection jig 93 and the holding part 3 by acceleration that is applied to the connection target 4 and the holding part 3 is prevented. Furthermore, at step C, connection target attraction is ON, so that a state where the connection target 4 is attracted on the holding part 3 is continuously provided from step B.

Then, as illustrated in FIG. 29, the control device 91 executes step D that moves the connection target 4 that is arranged at a position that is opposite with the target to be connected 5 at step C toward the target to be connected 5 in a positive direction of a Y-axis so as to start connection of the connection target 4 to the target to be connected 5. Step D is an example of a second step.

At step D, the connection target 4 that is arranged at a position that is opposite with the target to be connected 5 at step C is moved to an aperture position that is a position of the aperture 70 of the target to be connected 5. At step D, connection target attraction is ON, so that a state where the connection target 4 is attracted on the holding part 3 is continuously provided from step C.

Furthermore, at step D, floating is ON, so that the position correction part 1 of the connection jig 93 is provided in a floating state. Thereby, in a case where an error is caused in a position of the connection target 4 that is moved by the robot body part 90 with respect to the target to be connected 5, it is possible to move the holding part 3 to a position where such an error is absent. Therefore, it is possible for the connection jig 93 to correct an error in alignment according to teaching data accurately.

At step D, the control device 91 monitors a result of detection by the sensor 20 and determines whether or not the connection target 4 collides with the target to be connected 5. In a case where a part of the connection target 4 is provided at a position other than that of the aperture 70 of the target to be connected 5, the connection target 4 collides with the target to be connected 5 as illustrated in (b) of FIG. 30.

At step D, the control device 91, after the connection target 4 starts to move toward the target to be connected 5 in a positive direction of a Y-axis and before an amount of movement of the connection target 4 reaches a predetermined amount of movement P3 (see FIG. 31), determines that the connection target 4 collides with a part other than the aperture 70 of the target to be connected 5, as, for example, an insertion force that is a force that is detected as a moment by the sensor 20 exceeds a threshold Fth3. A threshold Fth3 is an example of a third threshold.

In a state where the connection target 4 collides with the target to be connected 5, it is not possible to continue movement of the connection target 4 toward an insertion direction to the target to be connected 5 subsequently. Hence, in a case where it is determined that the connection target 4 collides with the target to be connected 5 based on a result of detection by the sensor 20, the control device 91, for example, returns the connection target 4 to a position that is opposite with the target to be connected 5.

Furthermore, for example, the control device 91 shifts a position of the holding part 3 in a direction other than a Y-axis direction (for example, an X-axis direction or a Z-axis direction). Thereby, a relative position of the connection target 4 with respect to the target to be connected 5 is shifted. Then, the control device 91 thus shifts a position of the holding part 3, and subsequently, executes step C again.

At step D, in a case where the control device 91 determines that the connection target 4 does not collide with the target to be connected 5 and the connection target 4 moves to a position of the aperture 70 of the target to be connected 5 as illustrated in (c) of FIG. 30, it executes step E that further moves the connection target 4 that is moved at step D toward the target to be connected 5 in a positive direction of a Y-axis (see FIG. 28) and moves the connection target 4 to an insertion completion position of the target to be connected 5 as illustrated in FIG. 29. Step E is an example of a third step.

At step E, connection target attraction is ON, so that a state where the connection target 4 is attracted on the holding part 3 is continuously provided from step D. Furthermore, at step E, floating is ON, so that the position correction part 1 of the connection jig 93 is provided in a floating state. Thereby, it is possible for the control device 91 to execute step E accurately, even in a case where an error is caused in a position of the connection target 4 that is moved by the robot body part 90 with respect to the target to be connected 5.

At step E, the control device 91 also monitors a result of detection by the sensor 20 and determines whether or not the lock groove 60 of the connection target 4 passes over the lock part 71 of the target to be connected 5. At step E, for example, the control device 91 determines whether or not the lock groove 60 of the connection target 4 passes over the lock part 71 of the target to be connected 5 within a first movement range where an amount of movement of the connection target 4 is predetermined.

For example, in a case where an amount of movement of the connection target 4 is within a predetermined first movement range Rth1 (see FIG. 31), the control device 91 determines whether or not an insertion force that is detected by the sensor 20 exceeds a threshold Fth2. In a case where it is determined that an insertion force that is detected by the sensor 20 exceeds a threshold Fth2, the control device 91 determines that the lock groove 60 of the connection target 4 passes over the lock part 71 of the target to be connected 5. A threshold Fth2 is an example of a second threshold.

Furthermore, for example, in a case where an amount of movement of the connection target 4 is within a predetermined first movement range Rth1, the control device 91 determines that the lock groove 60 of the connection target 4 does not pass over the lock part 71 of the target to be connected 5 in a case where an insertion force that is detected by the sensor 20 does not exceed a threshold Fth2.

For example, in a case where a wiring pattern of the connection target 4, a contact 72 of the target to be connected 5, or the lock part 71 of the target to be connected 5, etc., is broken, an insertion force that is detected by the sensor 20 does not have to exceed a threshold Fth2 in a case where an amount of movement of the connection target 4 is within a predetermined first movement range Rth1.

Hence, in a case where it is determined that the lock groove 60 of the connection target 4 does not pass over the lock part 71 of the target to be connected 5, the control device 91 stops or re-executes connection of the connection target 4 to the target to be connected 5.

For example, in a case where it is determined that the lock groove 60 of the connection target 4 does not pass over the lock part 71 of the target to be connected 5 as illustrated in (d) of FIG. 30, the control device 91 moves the connection target 4 to a non-illustrated NGBOX and places the connection target 4 in such a non-illustrated NGBOX. Furthermore, in a case where it is determined that the lock groove 60 of the connection target 4 does not pass over the lock part 71 of the target to be connected 5, it is also possible for the control device 91 to, for example, cause an alarm so as to call a person.

Furthermore, in a case where it is determined that the lock groove 60 of the connection target 4 does not pass over the lock part 71 of the target to be connected 5, it is also possible for control device 91 to execute step C again. For example, the control device 91 returns the connection target 4 to a position that is opposite with the target to be connected 5 and shifts a position of the holding part 3 in a direction other than a Y-axis direction (for example, an X-axis direction or a Z-axis direction), so as to shift a relative position of the connection target 4 with respect to the target to be connected 5 and subsequently execute step C again.

Furthermore, at step E, in a case where it is determined that the lock groove 60 of the connection target 4 passes over the lock part 71 of the target to be connected 5, the control device 91 further moves the connection target 4 toward an insertion completion position of the target to be connected 5 in a positive direction of a Y-axis. Then, in a case where an amount of movement of the connection target 4 is within a predetermined second movement range Rth2 (see FIG. 31), the control device 91 determines whether or not the connection target 4 collides with an insertion completion position of the target to be connected 5.

For example, in a state where an amount of movement of the connection target 4 is within a predetermined second movement range Rth2, the control device 91 determines that connection of the connection target 4 to the target to be connected 5 is completed in a case where an insertion force that is detected by the sensor 20 exceeds a threshold Fth1. A threshold Fth1 is an example of a first threshold.

The control device 91 determines that connection of the connection target 4 to the target to be connected 5 is not completed in a case where an insertion force that is detected by the sensor 20 does not exceed a threshold Fth1. In a case where an insertion force that is detected by the sensor 20 does not exceed a threshold Fth1, no connection target 4 may reach an insertion completion position of the target to be connected 5 or a position of the connection target 4 may be shifted.

Hence, in a case where it is determined that connection of the connection target 4 to the target to be connected 5 is not completed, the control device 91 stops or re-executes connection of the connection target 4 to the target to be connected 5. For example, the control device 91 moves the connection target 4 to a non-illustrated NGBOX and places the connection target 4 in such a non-illustrated NGBOX. Furthermore, in a case where it is determined that connection of the connection target 4 to the target to be connected 5 is not completed, it is also possible for the control device 91 to, for example, cause an alarm so as to call a person.

Furthermore, in a case where it is determined that connection of the connection target 4 to the target to be connected 5 is not completed, it is also possible for the control device 91 to execute step C again. For example, the control device 91 returns the connection target 4 to a position that is opposite with the target to be connected 5 and shifts a position of the holding part 3 in a direction other than a Y-axis direction (for example, an X-axis direction or a Z-axis direction), so as to shift a relative position of the connection target 4 with respect to the target to be connected 5 and subsequently execute step C again.

In a case where connection of the connection target 4 to the target to be connected 5 is completed as illustrated in (f) of FIG. 30, the control device 91 executes step F that turns connection target attraction OFF, that is, stops an intake of air through an air pipe 94 as illustrated in FIG. 29, so as to end attraction of connection target 4 by the holding part 3.

Then, as illustrated in FIG. 29, the control device 91 executes step G that moves the holding part 3 away from the connection target 4, so as to execute separation from the connection target 4. At step G, in the position correction part 1, floating is OFF, that is, a lock state is provided, and in the holding part 3, attraction is OFF.

### 4. Change Method for Attachment Angles of First Joining Part 21 and Third Joining Part 23

Next, a change method for attachment angles of a first joining part 21 and a third joining part 23 will be explained.

First, from a state as illustrated in (a) of FIG. 32, attachments 28 that are attached to each of the first joining part 21 and the third joining part 23 are removed. Thereby, as illustrated in (b) of FIG. 32, it is possible to remove the first joining part 21 from a sensor 20 and it is possible to remove the third joining part 23 from a second joining part 22.

Then, as illustrated in (c) of FIG. 32, an angle of the first joining part 21 with respect to the sensor 20 is changed and an angle of the third joining part 23 with respect to the second joining part 22 is changed. Each of an angle of the first joining part 21 and an angle of the third joining part 23 is an angle around a rotation axis O (see FIG. 9).

Then, as illustrated in (d) of FIG. 32, the attachments 28 are attached to each of the first joining part 21 and the third joining part 23, so that changes of attachment angles of the first joining part 21 and the third joining part 23 are completed.

Attachment angles of the first joining part 21 and the third joining part 23 are changed, so that it is possible to readily change attachment angles of attachments of a holding part 3, etc., with respect to a connection jig 93. Additionally, a reason why it is possible to readily change an attachment angle of each of the first joining part 21 and the third joining part 23 as described above is because attachment holes 302 (see FIG. 8) and attachment holes 401 (see FIG. 10) are formed in a peripheral direction at regular intervals.

### 5. Variation

### 5.1. Arrangement of Bearing Part 25, Etc.

In an example as described above, the bearing part 25 is attached to the attachment hole 513 of the second joining part 22 as illustrated in FIG. 21 where such an example is not limitative and it may be attached to an attachment hole of the third joining part 23.

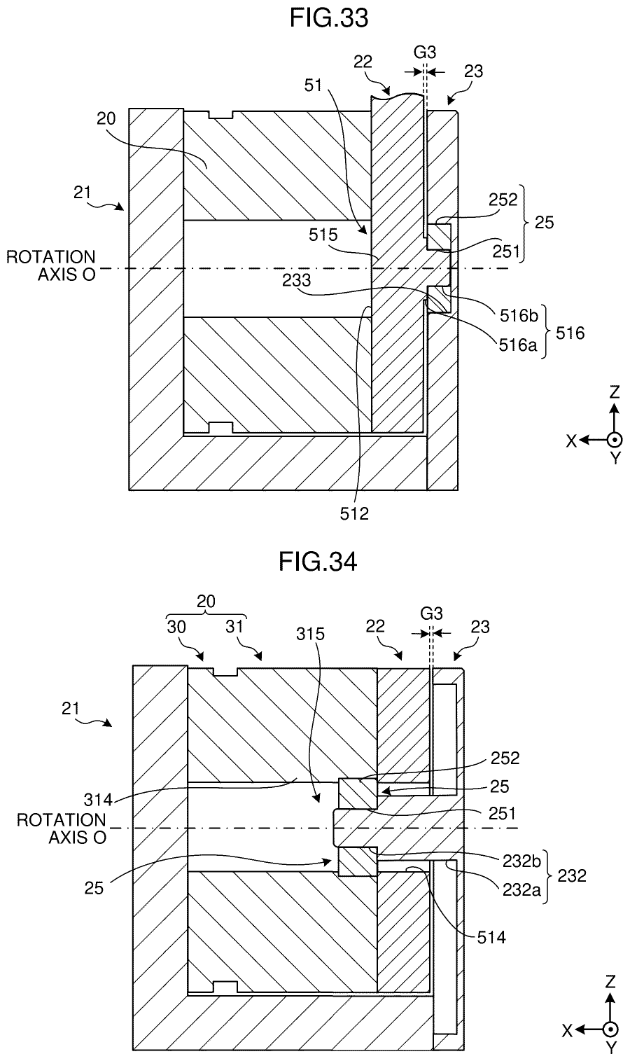

For example, a third joining part 23 as illustrated in FIG. 33 is different from the third joining part 23 as illustrated in FIG. 18 in that it has an attachment hole 233 instead of the shaft part 232 and the outer ring 252 of the bearing part 25 is attached to such an attachment hole 233.

Furthermore, a second joining part 22 as illustrate in FIG. 33 is different from the second joining part 22 as illustrated in FIG. 14 in that it has an attachment part 515 and a shaft part 516. The attachment part 515 is configured not to have the attachment hole 513 in the second joining part 22 as illustrated in FIG. 14.

The shaft part 516 has a first protrusion part 516a with a solid-cylindrical shape that protrudes in a direction that is orthogonal to the attachment surface 512 from a surface that is opposite with the third joining part 23 of the attachment part 515 and a second protrusion part 516b with a solid-cylindrical shape that is continuous with a leading end of the first protrusion part 516a and protrudes in a direction that is similar to that of the first protrusion part 516a so as to be coaxial with a central axis of the first protrusion part 516a. An outer diameter of the second protrusion part 516b is less than an outer diameter of the first protrusion part 516a.

The inner ring 251 of the bearing part 25 is inserted into the second protrusion part 516b of the shaft part 516 in the second joining part 22 so as to contact the first protrusion part 516a of the shaft part 516. Positioning of the bearing part 25 with respect to the shaft part 516 is executed by contact of the first protrusion part 516a of the shaft part 516.

The second protrusion part 516b of the shaft part 516 is inserted into the inner ring 251 of the bearing part 25 so as to be attached to the second protrusion part 516b of the shaft part 516, and the outer ring 252 of the bearing part 25 is inserted into the attachment hole 233 of the third joining part 23 so as to be attached to the attachment hole 233 of the third joining part 23. Thereby, a rotation axis of the bearing part 25 is arranged at a position where it is coaxial with a rotation axis O of the sensor 20. Additionally, the inner ring 251 of the bearing part 25 may be attached to the second protrusion part 516b of the shaft part 516 by an adhesive material, etc.

Furthermore, in an example as described above, the bearing part 25 is arranged between the second joining part 22 and the third joining part 23 and the third joining part 23 is attached to the second joining part 22 so as to be rotatable where such an example is not limitative as long as the bearing part 25 is arranged between the first joining part 21 and the third joining part 23.

For example, the bearing part 25 may be arranged between the sensor 20 and the third joining part 23 and the third joining part 23 may be attached to the sensor 20 so as to be rotatable. In such a case, the third joining part 23 is also supported by the second joining part 22 through the bearing part 25 and the sensor 20 so as to be rotatable.

For example, as illustrated in FIG. 34, the bearing part 25 may be arranged in a hollow part 315 of the fixation part 31 of the sensor 20. In an example as illustrated in FIG. 34, the inner ring 251 of the bearing part 25 that is arranged in the hollow part 315 of the fixation part 31 of the sensor 20 is attached to the second protrusion part 232b of the shaft part 232 and the outer ring 252 of the bearing part 25 is attached to an inner peripheral surface 314 of the fixation part 31 of the sensor 20.

An insertion hole 514 where the first protrusion part 232a of the shaft part 232 is inserted therethrough, instead of the attachment hole 513, is formed on the second joining part 22. The insertion hole 514 is provided with an outer diameter that is greater than that of the first protrusion part 232a so as not to contact the first protrusion part 232a in a state where the first protrusion part 232a is inserted therethrough.

Additionally, in an example as illustrated in FIG. 34, the inner ring 251 of the bearing part 25 is attached to the second protrusion part 232b of the shaft part 232 by inserting the second protrusion part 232b of the shaft part 232 thereinto, and the outer ring 252 of the bearing part 25 is inserted into the hollow part 315 of the fixation part 31 of the sensor 20 so as to be attached to the inner peripheral surface 314 of the fixation part 31 of the sensor 20. Additionally, the outer ring 252 of the bearing part 25 may be attached to the inner peripheral surface 314 of the fixation part 31 of the sensor 20 by an adhesive material, etc.

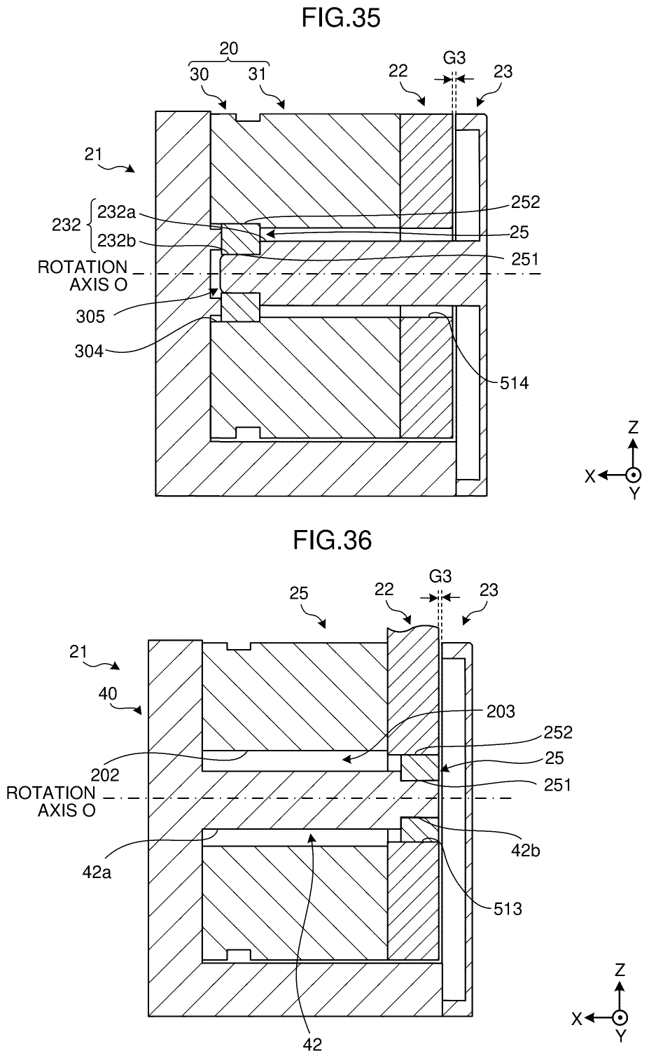

Furthermore, as illustrated in FIG. 35, the bearing part 25 may be arranged in a hollow part 305 of the passive part 30 of the sensor 20, instead of the hollow part 315 (see FIG. 34) of the fixation part 31 of the sensor 20. In an example as illustrated in FIG. 35, the inner ring 251 of the bearing part 25 that is arranged in the hollow part 305 of the passive part 30 of the sensor 20 is attached to the second protrusion part 232b of the shaft part 232, and the outer ring 252 of the bearing part 25 is attached to an inner peripheral surface 304 of the passive part 30 of the sensor 20.

Additionally, in an example as illustrated in FIG. 35, the inner ring 251 of the bearing part 25 is attached to the second protrusion part 232b of the shaft part 232 by inserting the second protrusion part 232b of the shaft part 232 thereinto, and the outer ring 252 of the bearing part 25 is inserted into the hollow part 305 of the passive part 30 of the sensor 20 so as to be attached to the inner peripheral surface 304 of the fixation part 31 of the sensor 20. Additionally, the outer ring 252 of the bearing part 25 may be attached to the inner peripheral surface 304 of the passive part 30 of the sensor 20 by an adhesive material, etc.

Furthermore, in an example as described above, the shaft part 516 (see FIG. 34) of the second joining part 22 or the shaft part 232 (see FIG. 35) of the third joining part 23 is inserted into the inner ring 251 of the bearing part 25 where a shaft part that is inserted into the inner ring 251 of the bearing part 25 may be provided on the first joining part 21.

For example, in an example as illustrated in FIG. 36, instead of the shaft part 516 (see FIG. 34) of the second joining part 22 or the shaft part 232 (see FIG. 35) of the third joining part 23, a shaft part 42 that extends in a direction of a rotation axis O and a direction toward the third joining part 23 from the attachment parts 40 and is inserted through a hollow part 203 of the sensor 20 is provided on the first joining part 21.

The shaft part 42 of the first joining part 21 has a first protrusion part 42a with a solid-cylindrical shape that protrudes in a direction of a rotation axis O and a second protrusion part 42b with a solid-cylindrical shape that is continuous with a leading end of the first protrusion part 42a and protrudes in a direction that is similar to that of the first protrusion part 42a so as to be coaxial with a central axis of the first protrusion part 42a. An outer diameter of the second protrusion part 42b is less than an outer diameter of the first protrusion part 42a.

The second protrusion part 42b of the shaft part 42 in the first joining part 21 is inserted into the inner ring 251 of the bearing part 25 and the bearing part 25 contacts the first protrusion part 42a of the shaft part 42. Positioning of the bearing part 25 with respect to the shaft part 42 is executed by contact of the first protrusion part 42a of the shaft part 42.

The second protrusion part 42b of the shaft part 42 is inserted into the inner ring 251 of the bearing part 25 so as to be attached to the second protrusion part 42b of the shaft part 42 and the outer ring 252 of the bearing part 25 is inserted into the attachment hole 513 of the second joining part 22 so as to be attached to the attachment hole 513 of the second joining part 22. Thereby, a rotation axis of the bearing part 25 is arranged at a position where it is coaxial with a rotation axis O of the sensor 20. Additionally, the inner ring 251 of the bearing part 25 may be attached to the second protrusion part 42b of the shaft part 42 by an adhesive material, etc.

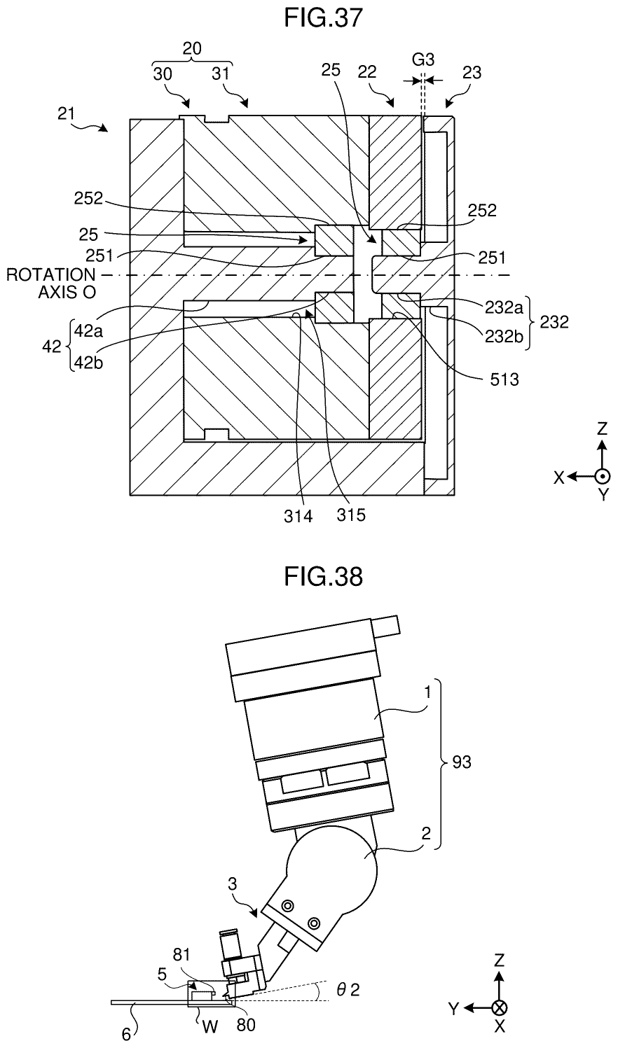

Furthermore, in an example as described above, the joining part 2 is configured to have a single bearing part 25 where it may be configured to have a plurality of bearing parts 25. For example, FIG. 37 includes the shaft part 42 of the first joining part 21 and a second bearing part 25, in addition to a configuration as illustrated in FIG. 22. An outer ring 252 of the second bearing part 25 is attached to the inner peripheral surface 314 of the fixation part 31 of the sensor 20.

The shaft part 42 as illustrated in FIG. 37 has a first protrusion part 42a with a solid-cylindrical shape that protrudes in a direction of a rotation axis O and a second protrusion part 42b with a solid-cylindrical shape that is continuous with a leading end of the first protrusion part 42a and protrudes in a direction that is similar to that of the first protrusion part 42a so as to be coaxial with a central axis of the first protrusion part 42a. An outer diameter of the second protrusion part 42b is less than an outer diameter of the first protrusion part 42a.

The shaft part 42 as illustrated in FIG. 37 is inserted into the inner ring 251 of the second bearing part 25 that is attached to the inner peripheral surface 314 of the fixation part 31 of the sensor 20 so as to be attached to the inner ring 251 of the second bearing part 25. Additionally, the outer ring 252 of the second bearing part 25 may be attached to the inner peripheral surface 304 of the passive part 30 of the sensor 20.

5.2. Connection Method for Connection Target 4 to Target to be Connected 5 that has Lock Member

A target to be connected 5 may be configured to have, for example, a lock member 81 as illustrated in FIG. 38. A target to be connected 5 as illustrated in FIG. 38 is different from the target to be connected 5 as illustrated in FIG. 27 in that it has the lock member 81. The lock member 81 of the target to be connected 5 has a configuration that prevents the connection target 4 that is inserted into and connected to the target to be connected 5 from being readily detached from the target to be connected 5 even if it is pulled in a detachment direction thereof.

In such a case, at a connection step for the connection target 4 to the target to be connected 5, in addition the plurality of steps as described above, an unlock step that moves the lock member 81 to an unlock position before connection of the connection target 4 to the target to be connected 5 and a lock step that moves the lock member 81 to a lock position where the connection target 4 is held with respect to the target to be connected 5 after connection of the connection target 4 to the target to be connected 5 are added thereto.

First, an unlock step will be explained. Such an unlock step moves the lock member 81 from a lock position where the connection target 4 is held with respect to the target to be connected 5 to an unlock position that is different from such a lock position. As illustrated in FIG. 38, a contact part 80 that is a protrusion part for releasing a lock state of the lock member 81 is provided on the holding part 3 that is attached to the connection jig 93.

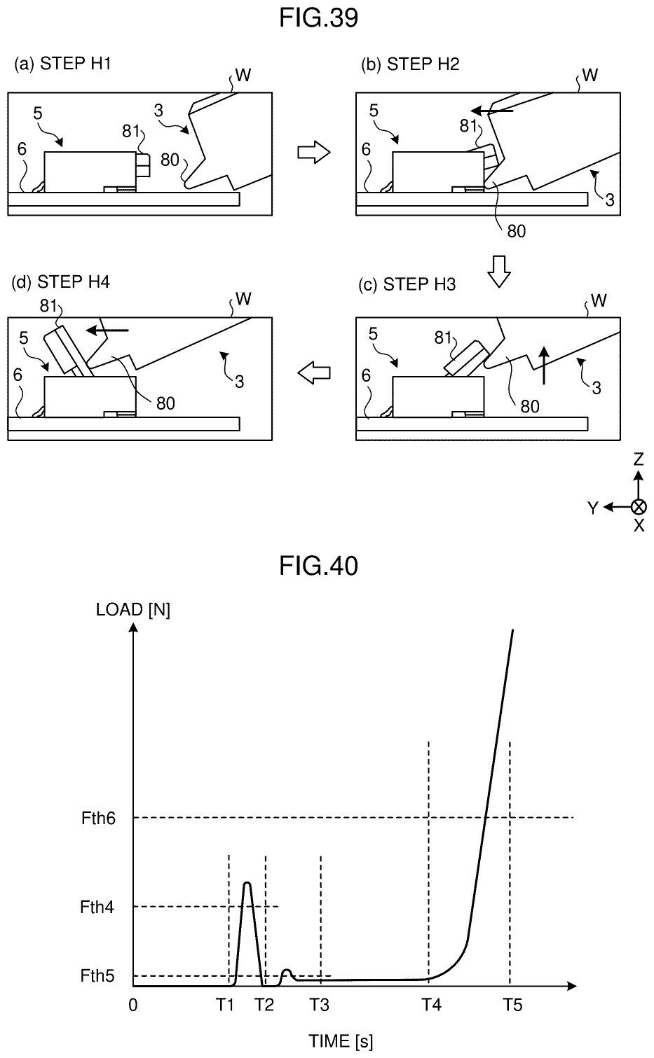

Herein, an example of an unlock step that uses the contact part 80 of the holding part 3 will be explained with reference to FIG. 39. The control device 91 controls each motor that is provided in the robot body part 90 so as to move the holding part 3 and hence execute an unlock step.

As illustrated in FIG. 38 and (a) of FIG. 39, the control device 91 executes step H1 that moves the holding part 3 in such a manner that a leading end part of the contact part 80 of the holding part 3 is provided under the lock member 81 (in a negative direction of a Z-axis).

Then, as illustrated in (b) of FIG. 39, the control device 91 executes step H2 that moves the holding part 3 toward the target to be connected 5 in a positive direction of a Y-axis so as to cause the contact part 80 of the holding part 3 to contact the target to be connected 5. At step H2, the control device 91 monitors a result of detection by the sensor 20 and determines whether or not the contact part 80 of the holding part 3 collides with the target to be connected 5.

At step H2, the control device 91 determines that the contact part 80 of the holding part 3 collides with the target to be connected 5 as, for example, a force that is detected as a moment by the sensor 20 exceeds a threshold Fth4 (see FIG. 40) within a predetermined first time range after movement of the contact part 80 of the holding part 3 toward the target to be connected 5 is started. A first time range is, for example, a range from time T1 to time T2 as illustrated in FIG. 40, and is a time range where an amount of movement of the holding part 3 is within a predetermined range. A threshold Fth4 is an example of a fourth threshold.

In a case where it is determined that the contact part 80 of the holding part 3 does not collide with the target to be connected 5, based on a result of detection by the sensor 20, the control device 91 stops or re-executes movement of the contact part 80 of the holding part 3.

For example, in a case where it is determined that the contact part 80 of the holding part 3 does not collide with the target to be connected 5, the control device 91 returns the contact part 80 of the holding part 3 to a position as illustrated in (a) of FIG. 39, and subsequently, shifts the holding part 3 to a position in a direction other than a Y-axis direction (for example, an X-axis direction or a Z-axis direction) so as to execute step H2 again. Furthermore, in a case where it is determined that the contact part 80 of the holding part 3 does not collide with the target to be connected 5, it is also possible for the control device 91 to, for example, cause an alarm so as to call a person.

In a case where it is determined that the contact part 80 of the holding part 3 collides with the target to be connected 5, based on a result of detection by the sensor 20, the control device 91 moves the contact part 80 of the holding part 3 in a direction away from the target to be connected 5 (a negative direction of a Y-axis) so as to release contact between the contact part 80 of the holding part 3 and the target to be connected 5 in a Y-axis direction. Subsequently, as illustrated in (c) of FIG. 39, the control device 91 executes step H3 that moves the contact part 80 of the holding part 3 in upward direction (a positive direction of a Z-axis).

At step H3, the control device 91 determines that pushing-upward of the lock member 81 by the contact part 80 of the holding part 3 is not normal, for example, in a case where a force that is detected by the sensor 20 is a threshold Fth5 (see FIG. 40) or less within a predetermined second time range after movement of the contact part 80 of the holding part 3 in an upward direction (a positive direction of a Z-axis) is started. A second time range is, for example, a range from time T2 to time T3 as illustrated in FIG. 40, and is a time range where an amount of movement of the holding part 3 in an upward direction (a positive direction of a Z-axis) is within a predetermined range.

At step H3, in a case where it is determined that pushing-upward of the lock member 81 by the contact part 80 of the holding part 3 is not normal, the control device 91 stops or re-executes movement of the contact part 80 of the holding part 3. Furthermore, at step H3, in a case where it is determined that pushing-upward of the lock member 81 by the contact part 80 of the holding part 3 is normal, a step H4 that moves the contact part 80 of the holding part 3 in a frontward direction (a positive direction of a Y-axis) as illustrated in (d) of FIG. 39 is executed.

Furthermore, at step H4, in a case where a force that is detected by the sensor 20 is a threshold Fth6 (see FIG. 40) or greater within a predetermined third time range, the control device 91 determines that unlock of the lock member 81 by the contact part 80 of the holding part 3 is completed, and starts to execute step A (see FIG. 31) as described above. A third time range is, for example, a range from time T4 to time T5 as illustrated in FIG. 40, and is a time range where an amount of movement of the holding part 3 in a frontward direction (a positive direction of a Y-axis) is within a predetermined range.

At step H4, in a case where it is determined that unlock of the lock member 81 by the contact part 80 of the holding part 3 is not completed, the control device 91 stops or re-executes movement of the contact part 80 of the holding part 3.

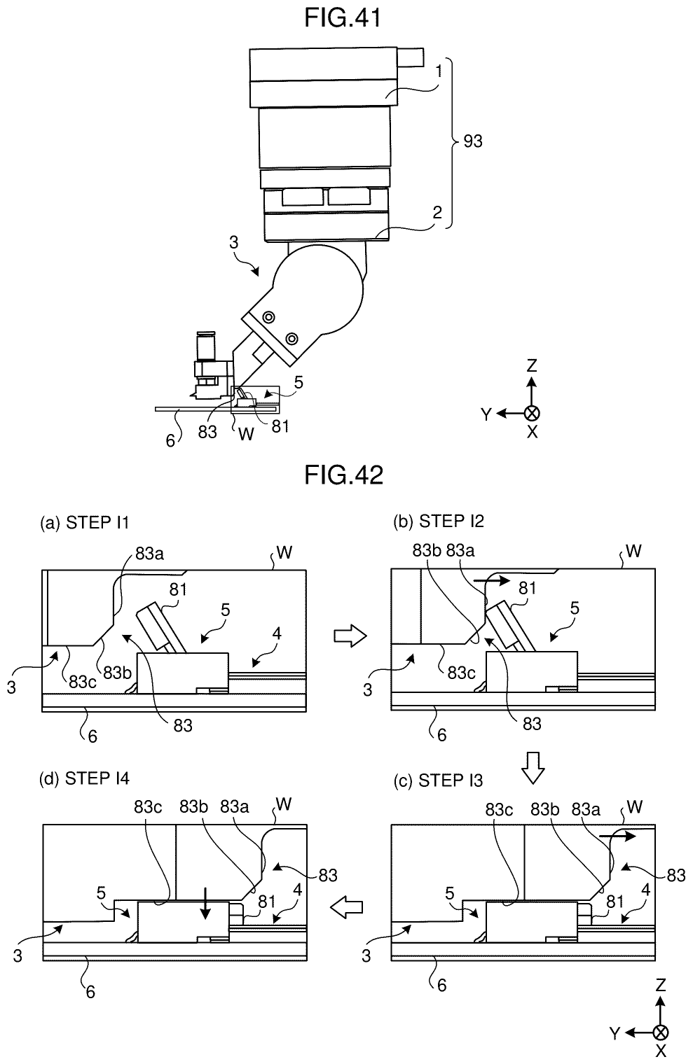

Then, a lock step will be explained. As illustrated in FIG. 41, the holding part 3 that is attached to the connection jig 93 is provided with a contact part 83 that is a protrusion part for setting the lock member 81 in the target to be connected 5 at a lock state thereof.

As illustrated in FIG. 42, the contact part 83 has a first flat surface 83a that extends in a plane that is orthogonal to frontward and backward directions (Y-axis directions), a sloping surface 83b that is continuous with such a first flat surface, and a second flat surface 83c that is continuous with the sloping surface 83b and extends in a plane that is orthogonal to upward and downward directions (Z-axis directions).

Herein, an example of a lock step that uses the contact part 83 of the holding part 3 will be explained with reference to FIG. 42. The control device 91 controls each motor that is provided in the robot body part 90 so as to move the holding part 3 and hence execute a lock step.

As illustrated in (a) of FIG. 42, the control device 91 executes step I1 where the contact part 83 of the holding part 3 moves the holding part 3 to a position that is opposite with the lock member 81 in a Y-axis direction.

Then, as illustrated in (b) of FIG. 42, the control device 91 executes step I2 that moves the holding part 3 in a backward direction (a negative direction of a Y-axis) that is a direction toward the lock member 81 of the target to be connected 5, so as to cause the first flat surface 83a of the contact part 83 in the holding part 3 to contact the lock member 81 of the target to be connected 5. At step I2, the control device 91 monitors a result of detection by the sensor 20 and determines whether or not the first flat surface 83a of the contact part 83 collides with the lock member 81 of the target to be connected 5.

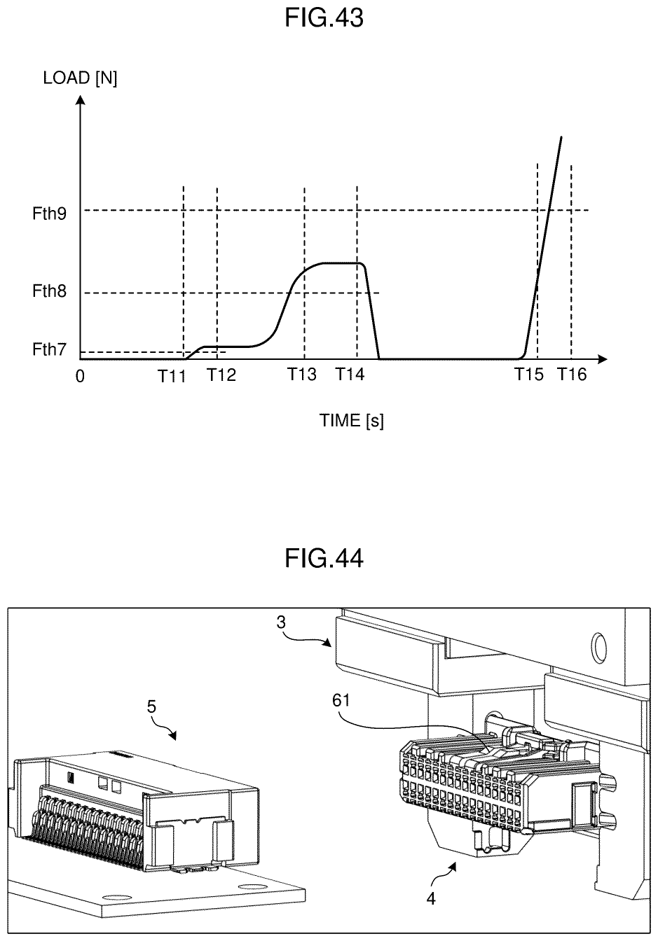

At step I2, the control device 91 determines that the contact part 83 of the holding part 3 collides with the lock member 81 of the target to be connected 5, for example, in a case where a force that is detected as a moment by the sensor 20 exceeds a threshold Fth7 (see FIG. 43) within a predetermined fourth time range after movement of the contact part 83 of the holding part 3 toward the lock member 81 of the target to be connected 5 is started. A fourth time range is, for example, a range from time T11 to time T12 as illustrated in FIG. 43, and is a time range where an amount of movement of the holding part 3 in a backward direction (a negative direction of a Y-axis) is within a predetermined range. A threshold Fth7 is an example of a fifth threshold.

In a case where it is determined that the contact part 83 of the holding part 3 does not collide with the lock member 81 of the target to be connected 5, based on a result of detection by the sensor 20, the control device 91 stops or re-executes movement of the contact part 83 of the holding part 3.

For example, in a case where it is determined that the contact part 83 of the holding part 3 does not collide with the lock member 81 of the target to be connected 5, the control device 91 returns the contact part 83 of the holding part 3 to a position as illustrated in (a) of FIG. 42, and subsequently, shifts the holding part 3 to a position in a direction other than a Y-axis direction (for example, an X-axis direction or a Z-axis direction) so as to execute step I2 again. Furthermore, in a case where it is determined that the contact part 83 of the holding part 3 does not collide with the lock member 81 of the target to be connected 5, it is also possible for the control device 91 to, for example, cause an alarm so as to call a person.

In a case where it is determined that the contact part 83 of the holding part 3 collides with the lock member 81 of the target to be connected 5, based on a result of detection by the sensor 20, the control device 91 executes step I3 that further moves the contact part 83 of the holding part 3 toward a backward direction (a negative direction of a Y-axis) as illustrated in (c) of FIG. 42. Thereby, the lock member 81 of the target to be connected 5 is pushed downward by the first flat surface 83a and the sloping surface 83b of the contact part 83 in the holding part 3.

At step I3, the control device 91 determines whether or not a force that is detected by the sensor 20 is a threshold Fth8 (see FIG. 43) or greater, for example, within a predetermined fifth time range after movement of the contact part 83 of the holding part 3 toward the target to be connected 5 is started. A fifth time range is, for example, a range from time T13 to time T14 as illustrated in FIG. 43, and is a time range where an amount of movement of the holding part 3 in a backward direction (a negative direction of a Y-axis) is within a predetermined range. A threshold Fth8 is set at a value that is less than a force that is needed when the holding part 3 closes the lock member 81.

In a case where it is determined that a force that is detected by the sensor 20 is a threshold Fth8 or greater, the control device 91 determines that step I3 is normally completed, and otherwise, determines that step I3 is not normally completed. In a case where it is determined that step I3 is not normally completed, the control device 91 stops or re-executes movement of the contact part 83 of the holding part 3.

Furthermore, in a case where it is determined that step I3 is normally completed, the control device 91 executes step I4 that moves the contact part 83 of the holding part 3 toward a downward direction (a negative direction of a Z-axis) as illustrated in (d) of FIG. 42. Thereby, the lock member 81 of the target to be connected 5 is pressed by the second flat surface 83c of the contact part 83 in the holding part 3.

At step I4, for example, in a case where a force that is detected by the sensor 20 is less than a threshold Fth9 (see FIG. 43), within a predetermined sixth time range, the control device 91 determines that the lock member 81 has an abnormality and stops a lock step. A sixth time range is, for example, a range from time T15 to time T16 as illustrated in FIG. 43, and is a time range where an amount of movement of the holding part 3 in a downward direction (a negative direction of a Z-axis) is within a predetermined range. A threshold Fth9 is set at a value that corresponds to a force that is needed for the holding part 3 to push the lock member 81 reliably.

Furthermore, at step I4, for example, in a case where a force that is detected by the sensor 20 is a threshold Fth9 or greater, within a predetermined sixth time range, the control device 91 completes a lock step. Additionally, the first flat surface 83a and the second flat surface 83c are not limited to flat surfaces as long as they are shapes that are allowed to execute an operation as described above.

### 5.3. Others

In an example as described above, the target to be connected 5 is a flexible printed circuit (FPC), and may be an electrical connector as illustrated in FIG. 44. A connection target 4 as illustrated in FIG. 44 has a lock part 61, and when such a target to be connected 5 is inserted into the connection target 4, the lock part 61 of the connection target 4 engages with a non-illustrated part to be locked in the target to be connected 5.

The control device 91 (see FIG. 1) determines whether or not a force that is detected by the sensor 20 is a predetermined threshold or greater when the lock part 61 of the connection target 4 engages with a non-illustrated part to be locked in the target to be connected 5. In a case where a force that is detected by the sensor 20 is a predetermined threshold or greater, the control device 91 determines that the lock part 61 of the connection target 4 passes over a part to be locked of the target to be connected 5.

Additionally, in an example as described above, the robot body part 90 is provided and explained as an example of an automated transportation part where such an automated transportation part is not limited to the robot body part 90 as long as it is capable of being controlled by the control device 91. For example, an automated transportation part may be a transportation mechanism (for example, a transportation device) that moves the holding part 3 and the connection jig 93 in X-axis directions along a rail, etc., may be a transportation mechanism that is capable of moving the holding part 3 and the connection jig 93 in X-axis directions and a Z-axis along a rail, etc., or may be another transportation mechanism.

As described above, a connection jig 93 according to an embodiment is a connection jig that connects a holding part 3 that holds a connection target 4 that is connected to a target to be connected 5 and an automated transportation part (for example, a robot body part 90) that automatically transports the connection target 4 that is held by the holding part 3 to a predetermined position, and include a sensor 20, a first joining part 21, a second joining part 22, a third joining part 23, and a bearing part 25. The sensor 20 is provided with one end in a direction of a rotation axis O where a passive part 30 is arranged and another end where a fixation part 31 is arranged, and detects a force around a rotation axis O with respect to the passive part 30. The first joining part 21 is arranged between the passive part 30 of the sensor 20 and the holding part 3, and joins the passive part 30 of the sensor 20 and the holding part 3. The second joining part 22 is arranged between the fixation part 31 of the sensor 20 and an automated transportation part, and joins the fixation part 31 of the sensor 20 and such an automated transportation part. The third joining part 23 is joined to the first joining part 21 and is supported by the second joining part 22 so as to be rotatable around a rotation axis O. The bearing part 25 is provided between and attached to the first joining part 21 and the third joining part 23 and is arranged at a position where a rotation axis thereof is coaxial with a rotation axis O of the sensor 20. Thereby, in a case where a force is applied to a holding part 3, it is possible for a connection jig 93 to convert such a force that is applied to the holding part 3 to a force in a direction that is capable of being detected by the sensor 20 (a force around a rotation axis O) accurately. Hence, it is possible for a connection jig 93 to execute connection between a connection target 4 and a target to be connected 5 accurately.

Furthermore, the bearing part 25 is arranged on the second joining part 22 and the third joining part 23 includes a shaft part 232 that is supported by the second joining part 22 through the bearing part 25. Thereby, it is possible for a connection jig 93 to execute connection between a connection target 4 and a target to be connected 5 accurately.

Furthermore, the bearing part 25 is arranged on the third joining part 23 and the second joining part 22 includes a shaft part 516 that supports the third joining part 23 through the bearing part 25. Thereby, it is possible for a connection jig 93 to execute connection between a connection target 4 and a target to be connected 5 accurately.

Furthermore, the fixation part 31 of the sensor 20 is formed into a hollow-cylindrical shape where a rotation axis O is provided as an axis line thereof, the bearing part 25 is arranged in a hollow part 315 of the fixation part 31 in the sensor 20, and the third joining part 23 includes a shaft part 232 that is supported by the fixation part 31 through the bearing part 25. Thereby, it is possible for a connection jig 93 to execute connection between a connection target 4 and a target to be connected 5 accurately.

Furthermore, the passive part 30 of the sensor 20 is formed into a hollow-cylindrical shape where a rotation axis O is provided as an axis line thereof, the bearing part 25 is arranged in a hollow part 305 of the passive part 30 in the sensor 20, and the third joining part 23 include a shaft part 232 that is supported by the passive part 30 through the bearing part 25. Thereby, it is possible for a connection jig 93 to execute connection between a connection target 4 and a target to be connected 5 accurately.

Furthermore, the sensor 20 is formed into a hollow-cylindrical shape or a solid-cylindrical shape where a rotation axis O is provided as an axis line thereof, and has a gap G1, G2 between an outer peripheral surface 201 of the sensor 20 and each of the first joining part 21 and the second joining part 22. Thereby, it is possible for a connection jig 93 to execute connection between a connection target 4 and a target to be connected 5 accurately.

Furthermore, the connection jig 93 includes a position correction part 1 that is arranged between the first joining part 21 and an automated transportation part (for example, a robot body part 90) and corrects a position of the holding part 3. Thereby, it is possible for a connection jig 93 to execute connection between a connection target 4 and a target to be connected 5 accurately.

Furthermore, the first joining part 21 and the third joining part 23 are attachable to the sensor 20 in such a manner that angles thereof around a rotation axis O are different from one another. Thereby, it is possible for a connection jig 93 to execute connection between a connection target 4 and a target to be connected 5 accurately, even if types of the connection target 4 and the target to be connected 5 are different from one another.

Furthermore, the third joining part 23 is supported by the second joining part 22 through the bearing part 25 in a state where a part of the second joining part 22 is interposed between it and the fixation part 31 of the sensor 20. Thereby, it is possible for a connection jig 93 to execute connection between a connection target 4 and a target to be connected 5 accurately while a third joining part 23 being capable of covering a part of a second joining part 22 is excellent in a design thereof.

Furthermore, a connection method for a connection target 4 to a target to be connected 5 that uses a connection jig 93 is a connection method that is characterized in by including a first step that arranges a connection target 4 so as to be opposite with a target to be connected 5, a second step that moves the connection target 4 that is arranged so as to be opposite with the target to be connected 5 at such a first step toward the target to be connected 5, so as to start connection of the connection target 4 to the target to be connected 5, and a third step that further moves the connection target 4 that is moved at such a second step toward the target to be connected 5, so as to move the connection target 4 to a position where connection of the connection target 4 to the target to be connected 5 is completed, where the third step determines that connection of the connection target 4 to the target to be connected 5 is completed in a case where a force that is detected by a sensor 20 exceeds a first threshold, so as to stop movement of the connection target 4. Step C is an example of a first step, step D is an example of a second step, and step E is an example of a third step. A threshold Fth1 is an example of a first threshold. Thereby, it is possible for a connection jig 93 to execute connection between a connection target 4 and a target to be connected 5 accurately.

Furthermore, such a third step stops or re-executes connection of the connection target 4 to the target to be connected 5 in a case where a force that is detected by a sensor 20 is a second threshold or less, when an amount of movement Pth of the connection target 4 toward the target to be connected 5 is provided at a position before reaching a position where a first threshold is determined, and within a predetermined range. A first movement range Rth1 is an example of a predetermined range and a threshold Fth2 is an example of a second threshold. Thereby, it is possible for a connection jig 93 to execute connection between a connection target 4 and a target to be connected 5 accurately.

Furthermore, such a second step stops or re-executes connection of the connection target 4 to the target to be connected 5 in a case where a force that is detected by a sensor 20 exceeds a third threshold after movement of the connection target 4 toward the target to be connected 5 is started and before an amount of movement Pth of the connection target 4 toward the target to be connected 5 reaches a predetermined amount of movement Pth. A threshold Fth3 is an example of a third threshold. Thereby, it is possible for a connection jig 93 to execute connection between a connection target 4 and a target to be connected 5 accurately.

Furthermore, such a first step includes a transportation step that transports the connection target 4 from a supply position where the connection target 4 is supplied thereto to a position where such a first step is started, and in such a transportation step, a position correction part 1 that is arranged between the second joining part 22 and an automated transportation part and corrects a position of a holding part 3 is provided in a lock state where a position of the holding part 3 is not corrected. Thereby, it is possible for a connection jig 93 to execute positioning of a connection target 4 and a target to be connected 5 accurately.

Furthermore, before such a first step, an unlock step is included that moves a contact part 80 that is provided on a holding part 3 and contacts a lock member 81 of the target to be connected 5 so as to move the lock member 81 from a lock position where the connection target 4 is held with respect to the target to be connected 5 to a unlock position that is different from such a lock position, where such an unlock step stops or re-executes movement of the contact part 80 of the holding part 3 in a case where a force that is detected by a sensor 20 is a fourth threshold or less. A threshold Fth4 is an example of a fourth threshold. Thereby, it is possible for a connection jig 93 to execute connection between a connection target 4 and a target to be connected 5 accurately.

Furthermore, after a third step, a lock step is included that moves a contact part 80 that is provided on a holding part 3 and contacts a lock member 81 of the target to be connected 5 so as to move the lock member 81 to a lock position where the connection target 4 is held with respect to the target to be connected 5, where such a lock step stops or re-executes movement of the contact part 80 of the holding part 3 in a case where a force that is detected by a sensor 20 is a fifth threshold or less. A threshold Fth7 is an example of a fifth threshold. Thereby, it is possible for a connection jig 93 to execute connection between a connection target 4 and a target to be connected 5 accurately.

Furthermore, a connection target 4 is a connector, a signal transfer medium with a plate shape, or a harness. Thereby, it is possible for a connection jig 93 to execute connection to a target to be connected 5 accurately even if it is a connector, a signal transfer medium with a plate shape, or a harness.

An aspect of an embodiment aims to provide a connection jig and a connection method that are capable of executing connection between a connection target and a target to be connected accurately.

A connection jig according to an aspect of an embodiment is a connection jig that connects a holding part that holds a connection target that is connected to a target to be connected and an automated transportation part that automatically transports a connection target that is held by the holding part to a predetermined position, and includes a sensor, a first joining part, a second joining part, a third joining part, and a bearing part. The sensor is provided with a passive part and a fixation part that are respectively arranged at one end and another end in a direction of a rotation axis thereof, and detects a force around the rotation axis with respect to the passive part. The first joining part is arranged between the passive part of the sensor and the holding part, and joins the passive part of the sensor and the holding part. The second joining part is arranged between the fixation part of the sensor and the automated transportation part, and joins the fixation part of the sensor and the automated transportation part. The third joining part is joined to the first joining part and is supported by the second joining part to be rotatable around the rotation axis. The bearing part is provided between and attached to the first joining part and the third joining part, and is arranged at a position where a rotation axis thereof is coaxial with the rotation axis of the sensor.

According to an aspect of an embodiment, it is possible to execute connection between a connection target and a target to be connected accurately.

### APPENDIX

Appendix (1): A connection jig that connects a holding part that holds a connection target that is connected to a target to be connected and an automated transportation part that automatically transports a connection target that is held by the holding part to a predetermined position, characterized by including:
a sensor that is provided with a passive part and a fixation part that are respectively arranged at one end and another end in a direction of a rotation axis thereof, and detects a force around the rotation axis with respect to the passive part;
a first joining part that is arranged between the passive part of the sensor and the holding part, and joins the passive part of the sensor and the holding part;
a second joining part that is arranged between the fixation part of the sensor and the automated transportation part, and joins the fixation part of the sensor and the automated transportation part;
a third joining part that is joined to the first joining part and is supported by the second joining part to be rotatable around the rotation axis; and
a bearing part that is provided between and attached to the first joining part and the third joining part, and is arranged at a position where a rotation axis thereof is coaxial with the rotation axis of the sensor.
Appendix (2): The connection jig according to Appendix (1), characterized in that
the bearing part is arranged on the second joining part, and
the third joining part includes a shaft part that is supported by the second joining part through the bearing part.
Appendix (3): The connection jig according to Appendix (1), characterized in that
the bearing part is arranged on the third joining part, and
the second joining part includes a shaft part that supports the third joining part through the bearing part.
Appendix (4): The connection jig according to Appendix (1), characterized in that
the fixation part of the sensor is formed into a hollow-cylindrical shape where the rotation axis is provided as an axial line thereof,
the bearing part is arranged in a hollow part of the fixation part in the sensor, and
the third joining part includes a shaft part that is supported by the fixation part through the bearing part.
Appendix (5): The connection jig according to Appendix (1), characterized in that
the passive part of the sensor is formed into a hollow-cylindrical shape where the rotation axis is provided as an axial line thereof,
the bearing part is arranged in a hollow part of the passive part in the sensor, and
the third joining part includes a shaft part that is supported by the passive part through the bearing part.
Appendix (6): The connection jig according to Appendix (1), characterized in that
the sensor is formed into a hollow-cylindrical shape or a solid-cylindrical shape where the rotation axis is provided as an axial line thereof, and has a gap between an outer peripheral surface of the sensor and each of the first joining part and the second joining part.
Appendix (7): The connection jig according to Appendix (1), characterized by including
a position correction part that is arranged between the first joining part and the automated transportation part, and corrects a position of the holding part.
Appendix (8): The connection jig according to Appendix (1), characterized in that
the first joining part and the third joining part are attachable to the sensor in such a manner that angles thereof around the rotation axis are different from one another.
Appendix (9): The connection jig according to Appendix (1), characterized in that
the third joining part is supported by the second joining part through the bearing part in a state where a part of the second joining part is interposed between it and the fixation part of the sensor.
Appendix (10): A connection method for the connection target to the target to be connected that uses the connection target according to any one of Appendices (1) to (8), characterized by including:
a first step that arranges the connection target to be opposite with the target to be connected;
a second step that moves the connection target that is arranged to be opposite with the target to be connected at the first step toward the target to be connected, to start connection of the connection target to the target to be connected; and
a third step that further moves the connection target that is moved at the second step toward the target to be connected, to move the connection target to a position where connection of the connection target to the target to be connected is completed, wherein
the third step determines that connection of the connection target to the target to be connected is completed in a case where a force that is detected by the sensor exceeds a first threshold, to stop movement of the connection target.
Appendix (11): The connection method according to Appendix (10), characterized in that
the third step stops or re-executes connection of the connection target to the target to be connected in a case where a force that is detected by the sensor is a second threshold or less, when an amount of movement of the connection target toward the target to be connected is provided at a position before reaching a position where the first threshold is determined, and within a predetermined range.
Appendix (12): The connection method according to Appendix (10), characterized in that
the second step stops or re-executes connection of the connection target to the target to be connected in a case where a force that is detected by the sensor exceeds a third threshold after movement of the connection target toward the target to be connected is started and before an amount of movement of the connection target toward the target to be connected reaches a predetermined amount of movement.
Appendix (13): The connection method according to Appendix (10), characterized in that
the first step includes a transportation step that transports the connection target from a supply position where the connection target is supplied thereto to a position where the second step is started, and
in the transportation step, a position correction part that is arranged between the second joining part and the automated transportation part and corrects a position of the holding part is provided in a lock state where a position of the holding part is not corrected.
Appendix (14): The connection method according to Appendix (10), characterized by including
a unlock step that moves a contact part that is provided on the holding part and contacts a lock member of the target to be connected, to move the lock member from a lock position where the connection target is held with respect to the target to be connected to an unlock position that is different from a lock position, before the first step, wherein
the unlock step stops or re-executes movement of the contact part of the holding part in a case where a force that is detected by the sensor is a fourth threshold or less.
Appendix (15): The connection method according to Appendix (10), characterized by including
a lock step that moves a contact part that is provided on the holding part and contacts a lock member of the target to be connected, to move the lock member to a lock position where the connection target is held with respect to the target to be connected, after the third step, wherein
the lock step stops or re-executes movement of the contact part of the holding part in a case where a force that is detected by the sensor is a fifth threshold or less.
Appendix (16): The connection method according to Appendix (10), characterized in that
the connection target is a connector, a signal transmission medium with a plate shape, or a harness.

It is possible for a person(s) skilled in the art to readily derive an additional effect(s) and/or variation(s). Hence, a broader aspect(s) of the present invention is/are not limited to a specific detail(s) and a representative embodiment(s) as illustrated and described above. Therefore, various modifications are possible without departing from the spirit or scope of a general inventive concept that is defined by the appended claim(s) and an equivalent(s) thereof.

What is claimed is:

1. A connection jig, comprising:
a sensor that is provided with a passive part and a fixation part that are respectively arranged at one end and another end in a direction of a rotation axis thereof, and detects a force around the rotation axis with respect to the passive part;
a first joining part that is arranged between the passive part of the sensor and a holding part that holds a connection target that is connected to a target to be connected, and joins the passive part of the sensor and the holding part;
a second joining part that is arranged between the fixation part of the sensor and an automated transportation part that automatically transports a connection target that is held by the holding part to a predetermined position, and joins the fixation part of the sensor and the automated transportation part;
a third joining part that is joined to the first joining part and is supported by the second joining part to be rotatable around the rotation axis; and
a bearing part that is provided between and attached to the first joining part and the third joining part, and is arranged at a position where a rotation axis thereof is coaxial with the rotation axis of the sensor.

2. The connection jig according to claim 1, wherein
the bearing part is arranged on the second joining part, and
the third joining part includes a shaft part that is supported by the second joining part through the bearing part.

3. The connection jig according to claim 1, wherein
the bearing part is arranged on the third joining part, and
the second joining part includes a shaft part that supports the third joining part through the bearing part.

4. The connection jig according to claim 1, wherein
the fixation part of the sensor is formed into a hollow-cylindrical shape where the rotation axis is provided as an axial line thereof,
the bearing part is arranged in a hollow part of the fixation part in the sensor, and
the third joining part includes a shaft part that is supported by the fixation part through the bearing part.

5. The connection jig according to claim 1, wherein
the passive part of the sensor is formed into a hollow-cylindrical shape where the rotation axis is provided as an axial line thereof,
the bearing part is arranged in a hollow part of the passive part in the sensor, and
the third joining part includes a shaft part that is supported by the passive part through the bearing part.

6. The connection jig according to claim 1, wherein
the sensor is formed into a hollow-cylindrical shape or a solid-cylindrical shape where the rotation axis is provided as an axial line thereof, and includes a gap between an outer peripheral surface of the sensor and each of the first joining part and the second joining part.

7. The connection jig according to claim 1, further comprising
a position correction part that is arranged between the first joining part and the automated transportation part, and corrects a position of the holding part.

8. The connection jig according to claim 1, wherein
the first joining part and the third joining part are attachable to the sensor in such a manner that angles of the first joining part and the third joining part around the rotation axis are different from one another.

9. The connection jig according to claim 1, wherein
the third joining part is supported by the second joining part through the bearing part in a state where a part of the second joining part is interposed between the third joining part and the fixation part of the sensor.

10. A connection method, comprising:
a first step of arranging a connection target to be opposite with a target to be connected;
a second step of moving the connection target that is arranged to be opposite with the target to be connected at the first step toward the target to be connected, to start connection of the connection target to the target to be connected; and
a third step of further moving the connection target that is moved at the second step toward the target to be connected, to move the connection target to a position where connection of the connection target to the target to be connected is completed, wherein
the third step determines that connection of the connection target to the target to be connected is completed in a case where a force that is detected by a sensor exceeds a first threshold, to stop movement of the connection target, and
the sensor is provided with a passive part and a fixation part that are respectively arranged at one end and another end in a direction of a rotation axis thereof, and detects a force around the rotation axis with respect to the passive part.

11. The connection method according to claim 10, wherein
the third step stops or re-executes connection of the connection target to the target to be connected in a case where a force that is detected by the sensor is a second threshold or less, when an amount of movement of the connection target toward the target to be connected is provided at a position before reaching a position where the first threshold is determined, and within a predetermined range.

12. The connection method according to claim 10, wherein
the second step stops or re-executes connection of the connection target to the target to be connected in a case where a force that is detected by the sensor exceeds a third threshold after movement of the connection target toward the target to be connected is started and before an amount of movement of the connection target toward the target to be connected reaches a predetermined amount of movement.

13. The connection method according to claim 10, wherein
the first step includes a transportation step that transports the connection target from a supply position where the connection target is supplied thereto to a position where the second step is started, and
in the transportation step, a position correction part that corrects a position of the holding part that holds the connection target is provided in a lock state where a position of the holding part is not corrected.

14. The connection method according to claim 10, further comprising
a unlock step that moves a contact part that is provided on a holding part that holds the connection target, and contacts a lock member of the target to be connected, to move the lock member from a lock position where the connection target is held with respect to the target to be connected to an unlock position that is different from a lock position, before the first step, wherein
the unlock step stops or re-executes movement of the contact part of the holding part in a case where a force that is detected by the sensor is a fourth threshold or less.

15. The connection method according to claim 10, further comprising
a lock step that moves a contact part that is provided on a holding part that holds the connection target, and contacts a lock member of the target to be connected, to move the lock member to a lock position where the connection target is held with respect to the target to be connected, after the third step, wherein
the lock step stops or re-executes movement of the contact part of the holding part in a case where a force that is detected by the sensor is a fifth threshold or less.

16. The connection method according to claim 10, characterized in that
the connection target is a connector, a signal transmission medium with a plate shape, or a harness.
